(19) United States
(12) Patent Application Publication
(10) Pub. No.: US 2022/0300839 A1
(43) Pub. Date: Sep. 22, 2022

(54) INFORMATION PROCESSING DEVICE, INFORMATION PROCESSING METHOD, AND RECORDING MEDIUM

(71) Applicant: NEC Corporation, Tokyo (JP)

(72) Inventor: Yoshikazu WATANABE, Tokyo (JP)

(73) Assignee: NEC Corporation, Tokyo (JP)

(21) Appl. No.: 17/689,043

(22) Filed: Mar. 8, 2022

(30) Foreign Application Priority Data
Mar. 16, 2021 (JP) 2021-042139

(51) Int. Cl. G06N 5/04; G06N 20/00; G06T 7/73; G06V 20/58

(52) U.S. Cl. CPC G06N 5/04; G06N 20/00; G06T 7/73; G06V 20/58; G06T 2207/20081

(57) ABSTRACT

An information processing device includes: a memory and, at least one processor coupled to the memory. The processor performs operations. The operations includes: applying inference target data in which at least part of data includes a first target object to a first learned model to infer the first target object as primary inference; generating aggregated data that is data having a smaller quantity than the inference target data by using the first target object inferred in the primary inference; generating a correspondence relation between a position of the first target object in the inference target data and a position of the first target object in the aggregated data; applying the aggregated data to a second learned model to infer the first target object as secondary inference; and inferring the first target object by using the first target object in a result of the secondary inference and the correspondence relation.

This application is based upon and claims the benefit of priority from Japanese Patent Application No. 2021-042139, filed on Mar. 16, 2021, the disclosure of which is incorporated herein in its entirety by reference.

### TECHNICAL FIELD

The present invention relates to information processing, and particularly to inference using machine learning.

### BACKGROUND ART

As one of main tasks using machine learning, there is an object detection task for an image. The object detection task is a task of generating a list of sets of a position and a class (type) of a target object present in an image. In recent years, an object detection task using, particularly, deep-learning among machine learning has been widely used.

In the object detection task, an image group for learning and information on a target object in each image are given as correct answer data in a learning phase of machine learning. The information on the target object is selected according to the specification of the object detection task. For example, the information on the target object includes coordinates (bounding box (BB)) of four vertices of a rectangular region in which the target object appears and a class of the target object. In the following description, the BB and the class are used as an example of the information on the target object. Then, the object detection task generates a learned model as a result of the machine learning using, for example, deep-learning by using the image group for learning and the information on the target object.

In a detection phase, the object detection task applies the learned model to the image including the target object to infer the target object included in the image, and outputs a set of the BB and the class for each target object included in the image. The object detection task may output an evaluation result (for example, confidence) of the result of the object detection together with the BB and the class.

For example, a monitoring system for persons and vehicles can be constructed by inputting an image from a monitoring camera to the object detection task and using the positions and classes of a person and a vehicle appearing in the image of the monitoring camera and detected by the object detection task. The object detection task may be used in combination with other recognition processing. For example, a license plate recognition system can be constructed by combining an object detection task of detecting a license plate of a car and optical character recognition (OCR) processing of recognizing characters on the detected license plate.

### SUMMARY

An object of the present invention is to provide an information processing device and the like that improve a throughput of inference of a target object.

An information processing device according to an aspect of the present invention includes: a memory; and at least one processor coupled to the memory. The processor performs operations. The operations include: applying inference target data in which at least part of data includes a first target object to a first learned model to infer the first target object as primary inference; generating aggregated data that is data having a smaller quantity than the inference target data by using the first target object inferred in the primary inference; generating a correspondence relation between a position of the first target object in the inference target data and a position of the first target object in the aggregated data; applying the aggregated data to a second learned model to infer the first target object as secondary inference; and inferring the first target object in the inference target data by using the first target object in a result of the secondary inference and the correspondence relation.

An information processing system according to an aspect of the present invention includes: the above-described information processing device; a data acquisition device that outputs inference target data to the information processing device; and a display device that acquires an inference result from the information processing device and displays the acquired inference result.

An information processing method according to an aspect of the present invention includes: applying inference target data in which at least part of data includes a first target object to a first learned model to infer the first target object as primary inference; generating aggregated data that is data having a smaller quantity than the inference target data by using the first target object inferred in the primary inference; generating a correspondence relation between a position of the first target object in the inference target data and a position of the first target object in the aggregated data; applying the aggregated data to a second learned model to infer the first target object as secondary inference; and inferring the first target object in the inference target data by using the first target object in a result of the secondary inference and the correspondence relation.

In the information processing method according to an aspect of the present invention, an information processing device executes the above-described information processing method, a data acquisition device outputs inference target data to an information processing device, and a display device acquires an inference result from the information processing device and displays the acquired inference result.

A non-transitory computer-readable recording medium according to an aspect of the present invention embodies a program. The program causes a computer to perform a method. The method includes: applying inference target data in which at least part of data includes a first target object to a first learned model to infer the first target object as primary inference; generating aggregated data that is data having a smaller quantity than the inference target data by using the first target object inferred in the primary inference; generating a correspondence relation between a position of the first target object in the inference target data and a position of the first target object in the aggregated data; applying the aggregated data to a second learned model to infer the first target object as secondary inference; and inferring the first target object in the inference target data by using the first target object in a result of the secondary inference and the correspondence relation.

### BRIEF DESCRIPTION OF THE DRAWINGS

Exemplary features and advantages of the present invention will become apparent from the following detailed description when taken with the accompanying drawings in which:

FIG. 1 is a block diagram illustrating an example of a configuration of an information processing device according to a first example embodiment;

FIG. 2 is a flowchart illustrating an example of an operation of generating a learned model in the information processing device according to the first example embodiment;

FIG. 3 is a flowchart illustrating an example of an operation of inferring a target object in the information processing device according to the first example embodiment;

FIG. 4 is a flowchart illustrating an example of post-processing in a data aggregation unit;

FIG. 5 is a diagram illustrating an example of a result of primary inference.

FIG. 6 is a diagram illustrating an example of aggregated data;

FIG. 7 is a diagram illustrating an example of a result of secondary inference.

FIG. 8 is a diagram illustrating an example of inference of a target object in inference target data;

FIG. 9 is a block diagram illustrating an example of a hardware configuration of the information processing device;

FIG. 10 is a block diagram illustrating an example of a configuration of an information processing system including the information processing device;

FIG. 11 is a block diagram illustrating an example of a configuration of an information processing device according to a second example embodiment;

FIG. 12 is a flowchart illustrating an example of a model switching operation in the information processing device according to the second example embodiment; and

FIG. 13 is a block diagram illustrating an example of a configuration of an information processing device according to a third example embodiment.

### EXAMPLE EMBODIMENT

Hereinafter, example embodiments of the present invention will be described with reference to the drawings. The drawings are intended to illustrate the example embodiments of the present invention. However, each example embodiment is not limited to the illustration of each drawing. Similar configurations in the drawings are denoted by the same reference signs, and repeated description thereof may be omitted. In the following description, the following is used as an example in the example embodiments.

(1) Inference target data: an image (a still image or a moving image) captured by a camera or the like,

(2) A task of inference: an object detection task of inferring a target object in the image,

(3) The result of the inference: a set of “a BB, a class, and confidence”, and

(4) Target object: a license plate (LP) of a vehicle.

However, these do not limit each example embodiment. For example, each example embodiment may use data different from an image as data to be processed. For example, each example embodiment may use depth data acquired using a depth sensor as data to be processed. Alternatively, each example embodiment may use three-dimensional data acquired by using Light Detection and Ranging (LIDAR) as the data to be processed. Alternatively, the result of the inference in each example embodiment is not limited to the set of “a BB, a class and confidence”. For example, each example embodiment may infer a target object included in the BB. In the following description, a set of “a BB, a class and confidence” may be simply referred to as a “BB” for convenience of description.

### First Example Embodiment

[Description of Configuration]

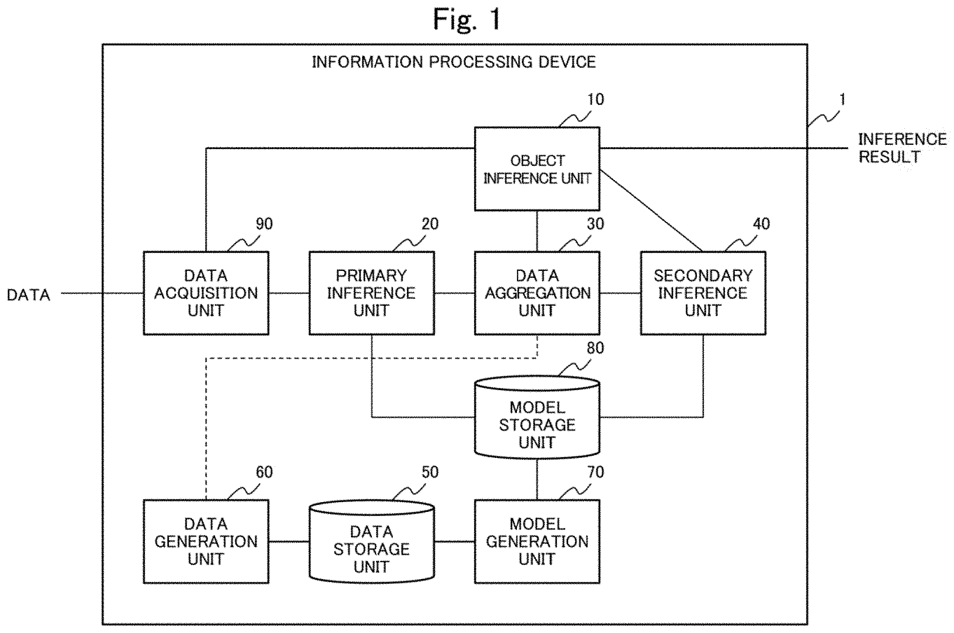

A configuration of a first example embodiment will be described with reference to the drawings. FIG. 1 is a block diagram illustrating an example of a configuration of an information processing device 1 according to the first example embodiment. The information processing device 1 includes an object inference unit 10, a primary inference unit 20, a data aggregation unit 30, a secondary inference unit 40, a data storage unit 50, a data generation unit 60, a model generation unit 70, a model storage unit 80, and a data acquisition unit 90.

The number of components and the connection relationship illustrated in FIG. 1 are examples. For example, the information processing device may include a plurality of data acquisition units 90. The information processing device 1 may be configured using a computer device including a central processing unit (CPU), a main memory, and a secondary storage device. In this case, the components of the information processing device 1 illustrated in FIG. 1 indicate functions achieved by using a CPU or the like. A hardware configuration will be further described later.

In the information processing device 1, a configuration for controlling the operation of each component is optional. For example, the information processing device 1 may include a control unit (not illustrated) that controls each component. Alternatively, a predetermined configuration (for example, the object inference unit 10) may control the operations of the components such as the primary inference unit 20, the data aggregation unit 30, and the secondary inference unit 40. Alternatively, each component may independently acquire data from another component and operate. Alternatively, each component may start an operation when acquiring data from other components. Therefore, in the following description, the description regarding the control of the operation of the component is omitted unless it is particularly required.

(1) Data Acquisition Unit 90

The data acquisition unit 90 acquires data (hereinafter referred to as “inference target data”) including an object to be inferred (hereinafter, referred to as a “target object”) from a predetermined device. It is sufficient if at least a part of the inference target data includes the target object. That is, at least a part of the inference target data may not include the target object. A device from which the data acquisition unit 90 acquires the inference target data is optional. For example, the data acquisition unit 90 may acquire an image from a monitoring camera as the inference target data.

(2) Primary Inference Unit 20

The primary inference unit 20 infers a target object (for example, a LP) in the inference target data. Hereinafter, the inference in the primary inference unit 20 is referred to as “primary inference”. The primary inference unit 20 may infer an object (for example, a LP peripheral object) having a predetermined positional relationship with the target object in addition to the target object (for example, a LP) as a target of the primary inference. Hereinafter, the object having the predetermined positional relationship with the target object is referred to as a “sub-target object”. In the following description, the primary inference unit 20 infers the target object and the sub-target object. However, this does not limit the operation of the primary inference unit 20. The primary inference unit 20 may not infer the sub-target object. In the following description, the inference target object in the information processing device 1 may be referred to as a “first target object”, and the sub-target object may be referred to as a “second target object”.

The predetermined positional relationship is optional. It is sufficient if the operator sets the positional relationship of the sub-target object in accordance with the target object. For example, an example of the positional relationship is “the target object is included in the sub-target object” or “the sub-target object includes the target object”. For example, when the target object is the LP of a vehicle, the sub-target objects are a front surface and a rear surface (hereinafter, collectively referred to as a “vehicle front and rear surface”) of the vehicle including the LP. However, this does not limit the positional relationship in the first example embodiment.

The primary inference unit 20 uses machine learning in the primary inference. Specifically, the primary inference unit 20 uses a model (hereinafter, referred to as a “learned model”) generated by using the machine learning stored in the model storage unit 80 to infer the target object and the sub-target object in the inference target data. Hereinafter, the learned model used by the primary inference unit 20 is referred to as a “learned model for primary inference” or a “first learned model”.

The primary inference unit 20 may correct the inference target data when applying the inference target data to the learned model for primary inference. For example, in a case where the inference target data is an image, the primary inference unit 20 may change the size or aspect ratio of the image.

(3) Data Aggregation Unit 30

The data aggregation unit 30 executes processing described below using the target object included in the result of the primary inference. However, in a case where the primary inference unit 20 infers the sub-target object in addition to the target object, the data aggregation unit 30 may use the sub-target object in addition to the target object. In the following description, the data aggregation unit 30 uses the target object and the sub-target object. However, the data aggregation unit 30 may not use the sub-target object. In this case, the data aggregation unit 30 may omit the operation related to the sub-target object in the following description.

The data aggregation unit 30 executes predetermined processing (for example, discarding the BB, filtering the BB, or adjusting the BB.) on the target object included in the result of the primary inference. Hereinafter, this processing is referred to as “post-processing”. The data aggregation unit 30 may execute the post-processing on a part of the target objects included in the result of the primary inference, or may execute post-processing on all the target objects. The data aggregation unit 30 may execute the post-processing on a part or all of the sub-target objects included in the result of the primary inference. In the following description, as an example, the data aggregation unit 30 executes the post-processing on all target objects and sub-target objects. However, the post-processing in the data aggregation unit 30 is not limited thereto.

The data aggregation unit 30 generates data (hereinafter, referred to as “aggregated data”) including the region of the target object and the region of the sub-target object in the inference target data (for example, the images of the target object and the sub-target object) and having a smaller quantity of data than the inference target data. Hereinafter, this processing is referred to as “aggregation”. That is, “aggregation” means extracting (or duplicating) regions including the target object and the sub-target object in the result of the primary inference from the inference target data, collecting the extracted (or duplicated) regions, and generating aggregated data that is data of a quantity smaller than the quantity of inference target data.

A quantity of data that is reduced with respect to the inference target data in the aggregated data is optional. It is sufficient if the operator makes a determination in accordance with the target object and the inference operation. For example, in a case where the number of pieces of data is used as the quantity of data, the aggregated data is data having a smaller number of pieces of data than the inference target data. For example, in a case where the data is a still image, the number of pieces of data is the number of still images. Alternatively, in a case where the data is a moving image having a fixed time length, the number of pieces of data is, for example, the number of moving images. In a case where a volume of data is used as the quantity of data, the aggregated data is data having a smaller volume (for example, capacity or area) of data than the inference target data. For example, in a case where the data is a still image, the volume of data is the volume of data of the entire still image. Alternatively, when the data is a video, the volume of data is a time length of the video.

In the generation of the aggregated data, the data aggregation unit 30 generates a correspondence relation (hereinafter referred to as “aggregation correspondence relation”) between the positions of the target object and the sub-target object in the inference target data and the respective positions of the target object and the sub-target object in the aggregated data. For example, in the case of inferring the BB, the data aggregation unit 30 generates, as the aggregation correspondence relation, coordinate transformation between the positions, orientations, and sizes of the BB of the target object and the BB of the sub-target object in the inference target data, and the positions, orientations, and sizes the BB of the target object and the BB of the sub-target object in the aggregated data.

In a case where the data is an image, the data aggregation unit 30 may generate, as an image in the aggregated data, an image having a size different from the size of the image in the inference target data. For example, the operator of the information processing device 1 may set the size of the image in the aggregated data in the data aggregation unit 30 based on the size of the inference target data, the performance of the hardware of the information processing device 1, the processing performance and the calculation accuracy of the learned model used for inference, and the like. The aggregated data is data used for inference by the secondary inference unit 40 to be described later. The inference target data is data used for inference by the primary inference unit 20. That is, the information processing device 1 may use data (for example, images of different sizes) of different sizes in the primary inference unit 20 and the secondary inference unit 40.

Next, details of the post-processing and the aggregation in the data aggregation unit 30 will be described. The “post-processing” and the “aggregation” in the data aggregation unit 30 are collectively referred to as “data aggregation”. That is, the operation of “data aggregation” is an operation including an operation of “post-processing” before the generation of aggregated data and an operation of “aggregation”. However, the data aggregation unit 30 may not execute the “post-processing”. In this case, the data aggregation is an operation of “aggregation” in the following description.

(3-1) Post-Processing

The data aggregation unit 30 executes post-processing described below before generating the aggregated data. For example, the data aggregation unit 30 discards an unnecessary region (for example, a BB) of the sub-target object from the result of the primary inference by using the positional relationship between the target object and the sub-target object and the result of the primary inference. For example, in the sub-target object included in the result of the primary inference, the data aggregation unit 30 discards the sub-target object in which the target object having a predetermined positional relationship with the sub-target object is included in the result of the primary inference. Alternatively, the data aggregation unit 30 may discard the BB of the sub-target object (for example, the vehicle front and rear surface) relevant to the target object (for example, the LP) inferred as the result of the primary inference. In other words, the data aggregation unit 30 uses, as the aggregation target, the sub-target object in which the target object having the predetermined positional relationship is not included in the result of the primary inference among the sub-target objects included in the result of the primary inference. The reason why this operation is used will be described using “the positional relationship in which the sub-target object includes the target object” and the “BB”.

The BB of the target object included in the result of the primary inference is included in the aggregated data in the aggregation operation to be described later. Therefore, even in a case where the BB of the sub-target object including the target object included in the result of the primary inference is not included in the aggregated data, the BB of the target object is included in the aggregated data. In a case where the BB of the sub-target object is included in the aggregated data, the aggregated data includes overlapping BBs as the BB of the target object. This adds an unnecessary load in the secondary inference. In this regard, the data aggregation unit 30 discards such a sub-target object. As a result, the information processing device 1 can improve the throughput in the case of using the sub-target object. On the other hand, the BB of the sub-target object in which the target object is not included in the result of the primary inference may include the target object not inferred in the primary inference. Therefore, when the BB of such a sub-target object is included in the aggregated data, the information processing device 1 can improve the accuracy of the secondary inference.

In this regard, the data aggregation unit 30 discards the sub-target object in which the target object is included in the result of the primary inference among the sub-target objects. In other words, the data aggregation unit 30 uses, as the aggregation target, the sub-target object in which the target object in the predetermined positional relationship is not included in the result of the primary inference among the sub-target objects in the predetermined positional relationship with the target object. As a result of this operation, the data aggregation unit 30 can reduce the quantity of generated aggregated data while improving the inference accuracy in the secondary inference. As a result, the information processing device 1 can improve the throughput (and the speed of inference).

For example, in a case where the positional relationship is “the vehicle front and rear surface (sub-target object) includes the LP (target object)”, the data aggregation unit 30 discards the BB of the vehicle front and rear surface including the LP included in the result of the primary inference in the region of the BB among the BB of the vehicle front and rear surface included in the result of the primary inference. In other words, the data aggregation unit 30 sets, as the aggregation target, the BB of the vehicle front and rear surface in which the LP is not inferred in the region among the BBs of the vehicle front and rear surface included in the result of the primary inference. In this manner, the data aggregation unit 30 generates the aggregated data not to include the result of the primary inference in which both the target object (for example, the LP) and the sub-target object (for example, the vehicle front and rear surface) are inferred.

The positional relationship between the target object and the sub-target object is not limited to the above, and is optional. For example, the data aggregation unit 30 determines the positional relationship between the target object and the sub-target object using the positional relationship set by the operator. In the determination of the positional relationship between the target object and the sub-target object, the data aggregation unit 30 may use a learned model that determines the positional relationship between the target object and the sub-target object generated by using predetermined machine learning in a device (not illustrated) or the like.

The data aggregation unit 30 may execute an operation different from discarding of the sub-target object. For example, in a case where the target object is detected, and the sub-target object relevant to the target object is detected, the data aggregation unit 30 may update the confidence of the BB of the target object without discarding the BB of the sub-target object. For example, in this case, the data aggregation unit 30 may add or multiply a predetermined value to the confidence of the BB of the target object, or may change the value of the confidence to a predetermined value.

The data aggregation unit 30 may filter the result of the primary inference as the post-processing before the generation of the aggregated data. The filtering target is optional. For example, the data aggregation unit 30 may filter the BB as the result of the primary inference by using at least one of the confidence relevant to the BB, the size or aspect ratio of the BB, and the position of the BB in the image. More specifically, for example, the data aggregation unit 30 may filter the BB based on a comparison between a predetermined threshold and the attribute value (for example, a size or aspect ratio) of the BB. For example, the data aggregation unit 30 may discard the BB having a size or an aspect ratio inappropriate for inference. The number of thresholds is not limited to one, and may be plural. For example, the threshold may be different for each class related to the BB. Alternatively, the threshold may be different depending on whether the sub-target object relevant to the target object is detected.

Alternatively, the data aggregation unit 30 may adjust at least one of the size and the aspect ratio of the acquired BB (the BB included in the result of the primary inference). The position and size of the BB included in the result of the primary inference may be different from the correct position and size. For example, the BB size may be smaller than the actual target object. In particular, in a case where the learned model used in the primary inference is small and lightweight, the inferred BB remarkably tends to be smaller than the actual target object.

When the BB having a size smaller than the actual target object is used as it is, the data aggregation unit 30 generates aggregated data including a target object partially missing. As a result, the secondary inference unit 40 to be described later performs inference using the aggregated data including the target object partially missing. As a result, a possibility that the result of the inference in the secondary inference unit 40 is not be a correct result (a possibility that the inference accuracy is lowered) increases. In this regard, as the post-processing, the data aggregation unit 30 may correct the size of the BB by adding a predetermined value to at least one of the height and the width of the BB of the target object and the BB of the sub-target object or multiplying at least one of the height and the width by a predetermined value. Alternatively, in a case where the aspect ratio of the BB deviates from a predetermined range, the data aggregation unit 30 may correct at least one of the height and the width of the BB in such a way that the aspect ratio falls within the predetermined range. For example, the data aggregation unit 30 may use, as the correction amount of the BB, different values in accordance with at least one of the BB size, the class, the position in the image, and the relative position with respect to a predetermined object in the image. Alternatively, in the case of the BB of the target object, the data aggregation unit 30 may use, as the correction amount of the BB, the different values in accordance with whether the sub-target object relevant to the target object is detected, the size of the BB of the relevant sub-target object, or the like. In these cases, the operator may set each value used by the data aggregation unit 30 in advance.

The data aggregation unit 30 may not execute the “post-processing”. However, in both the case of executing the post-processing and the case of not executing the post-processing, the data aggregation unit 30 executes the same operation as the aggregation operation described below. In this regard, in the following description, for convenience of description, the operation described below is described as an operation “after the post-processing” including a case where the post-processing is not executed. That is, in the following description, the operation “after the post-processing” includes an operation in “a case where the post-processing is not executed”.

(3-2) Aggregation

The data aggregation unit 30 generates aggregated data in which the regions (for example, the region including the BB of the target object and the region including the BB of the sub-target object) of the target object and the sub-target object in the result of the primary inference after the post-processing are collected. Specifically, the data aggregation unit 30 extracts (or duplicates) the region of the target object and the region of the sub-target object in the result of the primary inference after the post-processing in the inference target data, and generates the aggregated data in which the extracted (or duplicated) regions are collected.

The data aggregation unit 30 may generate one piece of aggregated data from a plurality of pieces of inference target data, or may generate a plurality of pieces of aggregated data from the plurality of pieces of inference target data. However, even in the case of the plurality of pieces of aggregated data, the quantity of the aggregated data is smaller than the quantity of the inference target data. In a case where the inference target data is an image, the data aggregation unit 30 may provide a predetermined gap (interval) between images in the generation of the aggregated data. As described above, the data aggregation unit 30 may execute aggregation without executing the post-processing. In this case, the data aggregation unit 30 executes aggregation by using the result of the primary inference.

The data aggregation unit 30 may combine at least one of the overlapping results of the primary inference and the adjacent results of the primary inference together in the result of the primary inference after the post-processing in the inference target data, and then aggregate the combined results. For example, the data aggregation unit 30 may combine overlapping BBs and BBs within a predetermined distance as a BB including all of the BBs, and then aggregate the combined BB. By using such an operation, the information processing device 1 can reduce the possibility of double detection of the same object and the possibility of overlooking the target object in the secondary inference.

The data aggregation unit 30 may perform aggregation after changing (for example, enlargement or reduction) the sizes of the target object and the sub-target object in the extracted (or duplicated) result (for example, BB) of the primary inference after the post-processing. When the sizes of the target object and the sub-target object are reduced, the quantity of aggregated data to be generated is reduced. As a result, the possibility of shortening the time of the secondary inference (that is, a possibility that throughput is improved) increases. Conversely, in a case where the target object and the sub-target object are increased in size, the size (that is, the size of the target object or the like in the secondary inference) of the target object or the like in the aggregated data to be generated is increased. As a result, there is a high possibility that the inference accuracy of the secondary inference is improved.

A method of changing the sizes of the target object and the sub-target object is optional. For example, based on the sizes (for example, comparison with a threshold) of the target object and the sub-target object in the result of the primary inference after the post-processing, the data aggregation unit 30 may determine whether to change the size and how to change the size when changing the size. Alternatively, the data aggregation unit 30 may use the result of the primary inference (for example, at least one of the position and size of the BB, the class, and the confidence) to determine whether to change the size and how to change the size when changing the size.

The data aggregation unit 30 may execute predetermined image processing (for example, complement processing) in changing the size. Alternatively, the data aggregation unit 30 may execute predetermined image processing (for example, brightness adjustment, luminance adjustment, color adjustment, contrast adjustment, or geometric correction) in addition to the change in size or instead of the change in size. The data aggregation unit 30 may adjust parameters related to image processing in accordance with the result (for example, at least one of the position and size of the BB, the class, and the confidence) of the primary inference.

The data aggregation unit 30 generates a correspondence relation (aggregation correspondence relation) between the region (for example, the position, orientation, and size of the BB) of the target object in the inference target data and the region (for example, the position, orientation, and size of the BB) of the target object in the aggregated data. In the case of aggregating the regions of the sub-target objects, the data aggregation unit 30 similarly generates a correspondence relation (aggregation correspondence relation) between the region of the sub-target object in the inference target data and the region of the sub-target object in the aggregated data also for the region of the sub-target object.

(4) Secondary Inference Unit 40

The secondary inference unit 40 infers the target object in the aggregated data generated by the data aggregation unit 30. Hereinafter, the inference in the secondary inference unit 40 is referred to as “secondary inference”. The secondary inference unit 40 uses machine learning in the secondary inference. Specifically, the secondary inference unit 40 uses the learned model stored in the model storage unit 80 to infer the target object in the aggregated data. Hereinafter, the learned model used by the secondary inference unit 40 is referred to as a “learned model for secondary inference” or a “second learned model”. For example, the secondary inference unit 40 uses the learned model for secondary inference to infer a set of “a BB, a class and confidence” of the target object included in the aggregated data as the result of secondary inference.

The secondary inference unit 40 may change the size of the aggregated data when applying the aggregated data to the learned model for secondary inference. For example, in a case where the aggregated data is an image, the secondary inference unit 40 may change the size or aspect ratio of the image in the aggregated data and then apply the changed image to the learned model for secondary inference.

(5) Data Generation Unit 60

The data generation unit 60 generates a learning data set used for machine learning by using a predetermined data set (hereinafter, referred to as an “original learning data set” or a “first data set”). The data included in the original learning data set is optional as long as the data is data relevant to a machine learning method. For example, the original learning data set is an image group including correct answer data related to the target object. The acquisition source of the original learning data set is optional. For example, the operator may store the original learning data set in the data storage unit 50 in advance. Alternatively, the data generation unit 60 may acquire the original learning data set from the device (not illustrated) in generating the learning data set.

Specifically, the data generation unit 60 generates the learning data set (hereinafter referred to as a “primary inference learning data set” or a “first learning data set”) used in machine learning for generating the learned model for primary inference used by the primary inference unit 20. Further, the data generation unit 60 generates the learning data set (hereinafter referred to as a “secondary inference learning data set” or a “second learning data set”) used for machine learning for generating the learned model for secondary inference used by the secondary inference unit 40.

For example, the data generation unit 60 generates the correct answer data of the target object and the sub-target object based on the correct answer data of the target object included in the original learning data set and the information on the positional relationship between the target object and the sub-target object. Then, the data generation unit 60 adds the generated correct answer data to the original learning data set to generate the primary inference learning data set. For example, the data generation unit 60 generates the BB (the correct answer data of the vehicle front and rear surface) obtained when the BB of the LP included in the original learning data set is enlarged by multiplying the height and the width by a predetermined value. Then, the data generation unit 60 adds the generated correct answer data of the vehicle front and rear surface to the original learning data set to generate the primary inference learning data set. Alternatively, the data generation unit 60 applies a predetermined learned model to the original learning data set as the correct answer data of the LP to infer the BB of the LP. Then, the data generation unit 60 generates, as the correct answer data of the vehicle front and rear surface, the BB obtained when the inferred BB of the LP is enlarged by multiplying the height and the width by the predetermined value. Then, the data generation unit 60 adds the generated LP and correct answer data of the vehicle front and rear surface to the original learning data set to generate the primary inference learning data set. Alternatively, the data generation unit 60 may apply the predetermined learned model to the original learning data set as the correct answer data to infer the BB of the LP and the BB on the vehicle front and rear surface, and add the inferred BB to the original learning data set to generate the primary inference learning data set.

Alternatively, for example, the data generation unit 60 generates the aggregated data from the correct answer data of the original learning data set by using the data aggregation unit 30. Then, the data generation unit 60 adds the correct answer data and the aggregated data to the original learning data set to generate the secondary inference learning data set. The data generation unit 60 may generate the secondary inference learning data set by using the primary inference learning data set or a data set obtained by adding the primary inference learning data set to the original learning data set instead of the original learning data set.

In a case where the primary inference unit 20 and the secondary inference unit 40 use the same learned model, the data generation unit 60 may generate one learning data set as the primary inference learning data set and the secondary inference learning data set. Alternatively, the data generation unit 60 may generate the primary inference learning data set and the secondary inference learning data set by using different original learning data sets.

Then, the data generation unit 60 stores the generated primary inference learning data set and secondary inference learning data set in the data storage unit 50. However, the data generation unit 60 may acquire at least one of the primary inference learning data set and the secondary inference learning data set from an external device (not illustrated). In this case, the data generation unit 60 stores the acquired primary inference learning data set or secondary inference learning data set in the data storage unit 50.

(6) Data Storage Unit 50

The data storage unit 50 stores the primary inference learning data set and the secondary inference learning data set. The data storage unit 50 may store the original learning data set. The acquisition source of the original learning data set is optional. For example, the operator may store the original learning data set in the data storage unit 50 in advance.

The information processing device 1 may use an external storage device (not illustrated) as the data storage unit 50. In this case, the information processing device 1 may not include the data storage unit 50 as a physical configuration. Alternatively, the information processing device 1 may acquire at least one of the primary inference learning data set and the secondary inference learning data set generated in the device (not illustrated) or the like, and store the acquired data set in the data storage unit 50. In a case where both the primary inference learning data set and the secondary inference learning data set are acquired, the information processing device 1 may not include the data generation unit 60.

(7) Model Generation Unit 70

The model generation unit 70 executes machine learning using the primary inference learning data set stored in the data storage unit 50 for a predetermined model, and generates the learned model for primary inference (first learned model) used by the primary inference unit 20. Further, the model generation unit 70 executes machine learning using the secondary inference learning data set stored in the data storage unit 50 for the predetermined model, and generates the learned model for secondary inference (second learned model) used by the secondary inference unit 40. The acquisition source of the model used for the generation of the learned model is optional. For example, the operator may store the model in the model storage unit 80 in advance. Alternatively, the model generation unit 70 may acquire the model used for the generation of the learned model from the device (not illustrated) in the generation of the learned model.

As the learned model for primary inference and the learned model for secondary inference, the model generation unit 70 may generate models similar in the type, network structure, size, and the like of the model, or may generate models different from each other. For example, the model generation unit 70 may generate the same model as the learned model for primary inference and the learned model for secondary inference. That is, the model generation unit 70 may generate one model as the learned model for primary inference and the learned model for secondary inference. For example, in a case where the primary inference unit 20 and the secondary inference unit 40 use the same learned model, the model generation unit 70 may generate one learned model as the learned model for primary inference and the learned model for secondary inference. Alternatively, the model generation unit 70 may generate, as the learned model for primary inference and the learned model for secondary inference, models that are different from each other but are similar in the type, network structure, size, and the like of the model.

Alternatively, the model generation unit 70 may generate, as the learned model for primary inference and the learned model for secondary inference, models that are different in at least one of the type, network structure, size, and the like of the model. For example, in a case where both learned models are generated by using deep-learning, the model generation unit 70 may generate, as the learned model for primary inference and the learned model for secondary inference, models that are different in at least one of the type, network structure, size, and the like of the model. For example, the model generation unit 70 may generate, as the learned model for primary inference, a small and lightweight learned model with respect to the learned model for secondary inference. However, this does not limit the learned model generated by the model generation unit 70.

The machine learning method used by the model generation unit 70 is optional. For example, the model generation unit 70 may generate at least one of the learned model for primary inference and the learned model for secondary inference by using deep-learning. The model generation unit 70 may use the same machine learning or different types of machine learning as the machine learning used for the generation of the learned model for primary inference and the machine learning used for the generation of the learned model for secondary inference. In the description of the first example embodiment, as an example, the model generation unit 70 generates different learned models as the learned model for primary inference and the learned model for secondary inference.

Then, the model generation unit 70 stores the generated learned model for primary inference and learned model for secondary inference in the model storage unit 80. However, the model generation unit 70 may acquire at least one of the learned model for primary inference and the learned model for secondary inference from the external device (not illustrated). In this case, the model generation unit 70 stores the acquired learned model for primary inference or learned model for secondary inference in the model storage unit 80.

(8) Model Storage Unit 80

The model storage unit 80 stores the learned model for primary inference and the learned model for secondary inference. The model storage unit 80 may store the model used by the model generation unit 70 to generate the learned model. For example, the operator may store the model used for the generation of the learned model in the model storage unit 80 in advance.

The information processing device 1 may use the external storage device (not illustrated) as the model storage unit 80. In this case, the information processing device 1 may not include the model storage unit 80 as a physical configuration. Alternatively, the information processing device 1 may acquire at least one of the learned model for primary inference and the learned model for secondary inference generated in the device (not illustrated) or the like, and store the acquired model in the model storage unit 80. In a case where both the learned model for primary inference and the learned model for secondary inference are acquired, the information processing device 1 may not include the data storage unit 50, the data generation unit 60, and the model generation unit 70.

(9) Object Inference Unit 10

The object inference unit 10 uses the result (the target object in the aggregated data) of the secondary inference in the secondary inference unit 40 and the aggregation correspondence relation generated by the data aggregation unit 30 in the generation of the aggregated data to infer the target object in the inference target data. For example, in a case where the coordinate transformation of the BB is stored as the aggregation correspondence relation, the object inference unit 10 applies, as the inference position of the BB, the inverse transformation of the coordinate transformation to the coordinates of the BB inferred as the result of the secondary inference to calculate the position of the BB of the target object in the inference target data. For example, in a case where the rectangle of the BB obtained as the result of the secondary inference protrudes from the rectangle (the rectangle generated based on the BB obtained as the result of the primary inference) in the aggregated data, the object inference unit 10 may discard the BB. Alternatively, for example, in a case where a value (quotient) obtained by dividing the area of the product set portion of the rectangle of the BB obtained as the result of the secondary inference and the rectangle on the aggregated data by the area of the rectangle of the BB obtained as the result of the secondary inference is less than a predetermined threshold, the object inference unit 10 may discard the BB. In a case where the quotient is equal to or more than a predetermined threshold, the object inference unit 10 may correct the rectangle of the BB to the product set portion.

[Description of Operation]

(A) Operation of Generating Learned Model

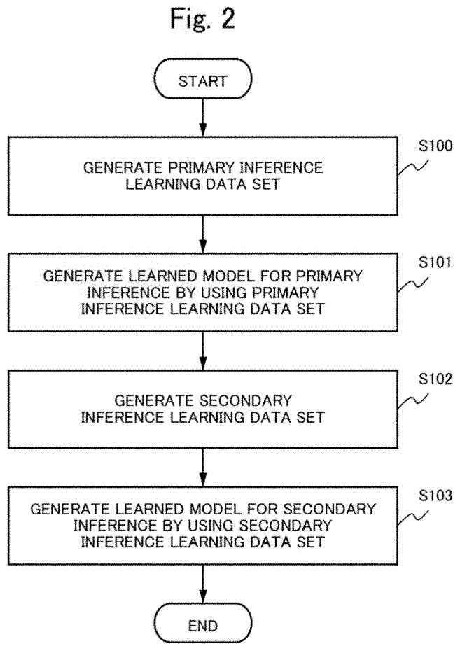

FIG. 2 is a flowchart illustrating an example of an operation of generating a learned model in the information processing device 1 according to the first example embodiment. The information processing device 1 starts the generation of the learned model with a predetermined condition as a trigger. For example, the information processing device 1 starts the generation of the learned model in response to an instruction from the operator. In this case, at the start of the operation, the information processing device 1 may acquire parameters necessary for the generation of the learned model from the operator.

The parameters necessary for the generation of the learned model are optional. For example, in a case where the data storage unit 50 stores a plurality of learning data sets, the parameter is information indicating which learning data set is used. Alternatively, the parameter may be a parameter related to machine learning processing in the model generation unit 70. The information processing device 1 may acquire other information in addition to the parameter. For example, the data generation unit 60 may acquire at least a part of the learning data set from the operator. In this case, the data generation unit 60 stores the acquired learning data set in the data storage unit 50.

The data generation unit 60 generates the primary inference learning data set by using the original learning data set stored in the data storage unit 50 (step S100). For example, the data generation unit 60 generates the primary inference learning data set by using the correct answer data included in the original learning data set. Then, the data generation unit 60 stores the primary inference learning data set in the data storage unit 50. The model generation unit 70 executes machine learning in the predetermined model by using the primary inference learning data set and generates the learned model for primary inference (step S101). Then, the model generation unit 70 stores the learned model for primary inference in the model storage unit 80.

The data generation unit 60 generates a secondary inference learning data set by using the original learning data set stored in the data storage unit 50 (step S102). For example, the data generation unit 60 may generate the aggregated data by using the correct answer data of the original learning data set and generate the secondary inference learning data set including the correct answer data and the aggregated data. Then, the data generation unit 60 stores the generated secondary inference learning data set in the data storage unit 50. The model generation unit 70 executes machine learning in the predetermined model by using the secondary inference learning data set and generates the learned model for secondary inference (step S103). Then, the model generation unit 70 stores the learned model for secondary inference in the model storage unit 80.

After the generation of the learned model, the information processing device 1 may notify the operator of the execution result.

(B) Operation of Inference

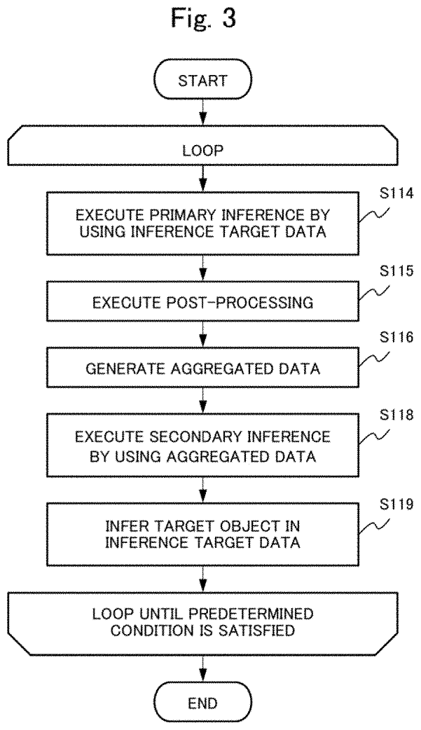

FIG. 3 is a flowchart illustrating an example of an operation of inferring the target object in the information processing device 1 according to the first example embodiment. The model storage unit 80 stores the learned model before the inference operation is started. However, in a case where the model storage unit 80 does not store the learned model, the information processing device 1 may start the inference operation after executing the operation of “(A) generating a learned model” to generate the learned model.

The information processing device 1 starts the inference of the target object with a predetermined condition as a trigger. For example, the information processing device 1 starts the inference of the target object in response to an instruction from an operator. The information processing device 1 may acquire parameters (for example, the designation of a learned model to be used) from the operator in the inference of the target object. However, the information processing device 1 may use the parameter given in advance. Alternatively, the information processing device 1 may automatically start the inference of the target object after the activation of the device. Alternatively, when the data acquisition unit 90 acquires one piece or a predetermined quantity of inference target data, the information processing device 1 may execute an operation described below. However, the information processing device 1 may start the inference operation asynchronously with the acquisition of the inference target data in the data acquisition unit 90. The data acquisition unit 90 may acquire the inference target data in advance and store the inference target data in a storage unit (not illustrated). In this case, the primary inference unit 20 may acquire the inference target data from the storage unit.

The primary inference unit 20 executes the primary inference by using the inference target data (step S114). The primary inference unit 20 may execute the primary inference by collecting the predetermined quantity of inference target data. Hereinafter, the predetermined quantity of inference target data collectively executed by the primary inference unit 20 is referred to as an “inference target data group”. For example, in a case where the inference target data is an image including the target object, the primary inference unit 20 infers an aggregation of sets of “a BB, a class and confidence” from the image of the predetermined quantity of inference target data (inference target data group) as the primary inference. The primary inference unit 20 may infer the sub-target object in the inference target data group.

The primary inference unit 20 may determine the inference target data group to be inferred collectively by using a condition different from the quantity of inference target data. For example, the primary inference unit 20 may determine the inference target data group to be inferred collectively by using at least one of the following conditions.

(a) In a case where the number of BBs inferred in the primary inference reaches a predetermined number,

(b) In a case where the sum of the sizes of the BBs inferred in the primary inference reaches a predetermined value,

(c) In a case where the number of pieces of aggregated data is inferred and the inferred number of pieces of aggregated data reaches a predetermined value, and

(d) The inference target data for which a predetermined time has elapsed since acquisition by the information processing device 1.

However, the primary inference unit 20 may execute the primary inference on all the acquired inference target data. In a case where the primary inference is executed for the inference target data group, the primary inference unit 20 may perform the primary inference on at least some inference target data included in the inference target data group in parallel, may sequentially process all the primary inferences, or may combine the parallel processing and the sequential processing.

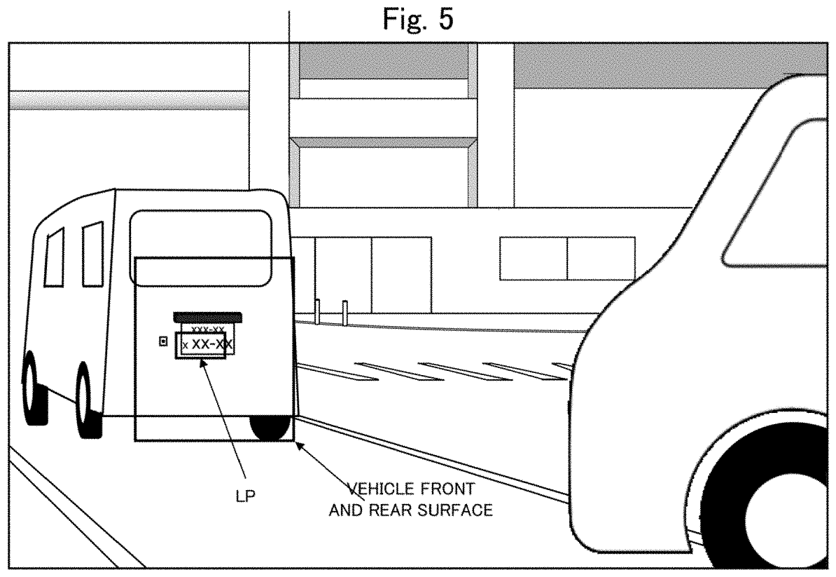

FIG. 5 is a diagram illustrating an example of the result of the primary inference. In FIG. 5, a small inner rectangle of two rectangles is the BB of the target object (LP) obtained as the result of the primary inference. The large outer rectangle is the BB of the sub-target object (vehicle front and rear surface) obtained as the result of the primary inference. In FIG. 5, the display of the class and the confidence is omitted. The description returns to the description with reference to FIG. 3.

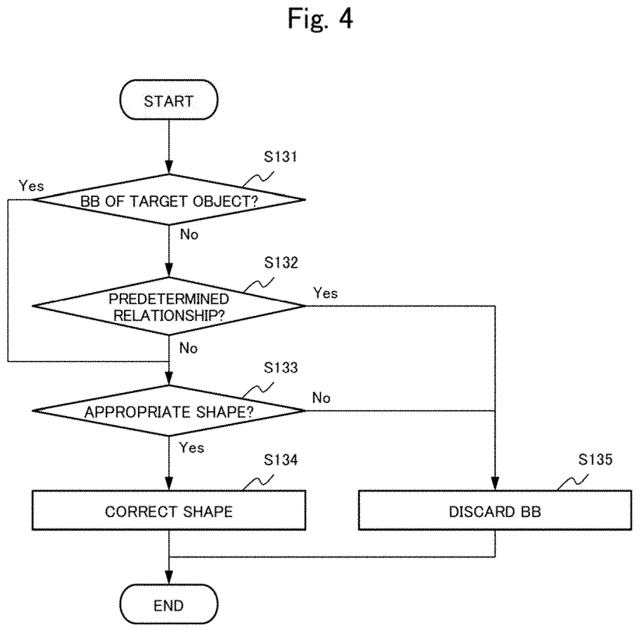

The data aggregation unit 30 executes the post-processing on some or all of the results of the primary inference (step S115). For example, the data aggregation unit 30 executes the filtering and adjustment of the BB by using the attribute of the BB and the information on the positional relationship between the target object and the sub-target object. FIG. 4 is a flowchart illustrating an example of the post-processing in the data aggregation unit 30. More specifically, FIG. 4 is an example of an operation of the post-processing in the data aggregation unit 30 in a case where the BB is inferred as the result of primary inference. Hereinafter, an operation in a case where the target object is an LP, and the sub-target object is a vehicle front and rear surface including the LP will be described with reference to FIG. 4.

The data aggregation unit 30 determines whether the BB is the BB of the target object (LP) (step S131). A case where the BB is not the BB of the target object (LP) is a case where the BB is the BB of the sub-target object (vehicle front and rear surface).

When the BB is not the BB of the target object (LP) (No in step S131), the data aggregation unit 30 determines whether the sub-target object (vehicle front and rear surface) has a predetermined relationship with the target object (LP) included in the result of the primary inference (step S132). For example, the data aggregation unit 30 determines whether the BB of the sub-target object (vehicle front and rear surface) includes the BB of the target object (LP) included in the result of the primary inference.

In the case of the BB of the target object (LP) (Yes in step S131) or in a case where the sub-target object (vehicle front and rear surface) does not have the predetermined relationship (No in step S132), the data aggregation unit 30 determines whether the BB has a shape appropriate for use as the aggregated data (step S133). For example, the data aggregation unit 30 determines whether the size and aspect ratio of the BB are within a predetermined threshold range (for example, whether the BB is too small).

In a case where the BB has an appropriate shape (Yes in step S133), the data aggregation unit 30 corrects the BB to a shape appropriate for the generation of the aggregated data (step S134). For example, the data aggregation unit 30 sets the size and aspect ratio of the BB to values appropriate for the generation of the aggregated data. For example, the data aggregation unit 30 may change the size of the BB by multiplying the height and the width of the BB by a predetermined value. Alternatively, the data aggregation unit 30 may correct the height and width of the BB in such a way that the aspect ratio of the BB falls within a predetermined range.

In a case where the sub-target object has the predetermined relationship (Yes in step S132) or a case where the BB does not have an appropriate shape (NO in step S133), the data aggregation unit 30 discards the BB (step S135). That is, the data aggregation unit 30 does not include the BB in the aggregated data. In this manner, the data aggregation unit 30 executes the post-processing on the result of the primary inference. The description returns to the description with reference to FIG. 3.

The data aggregation unit 30 generates the aggregated data by using all the results of the primary inference after the post-processing (step S116). For example, in a case where the inference target data is an image, the data aggregation unit 30 generates an image obtained by collecting the images of the region (BB) of the target object and the region (BB) of the sub-target object inferred as the result of the primary inference. In the result of the primary inference, the data aggregation unit 30 may generate the aggregated data by using a region obtained by combining at least a part of the overlapping regions and the adjacent regions into one.

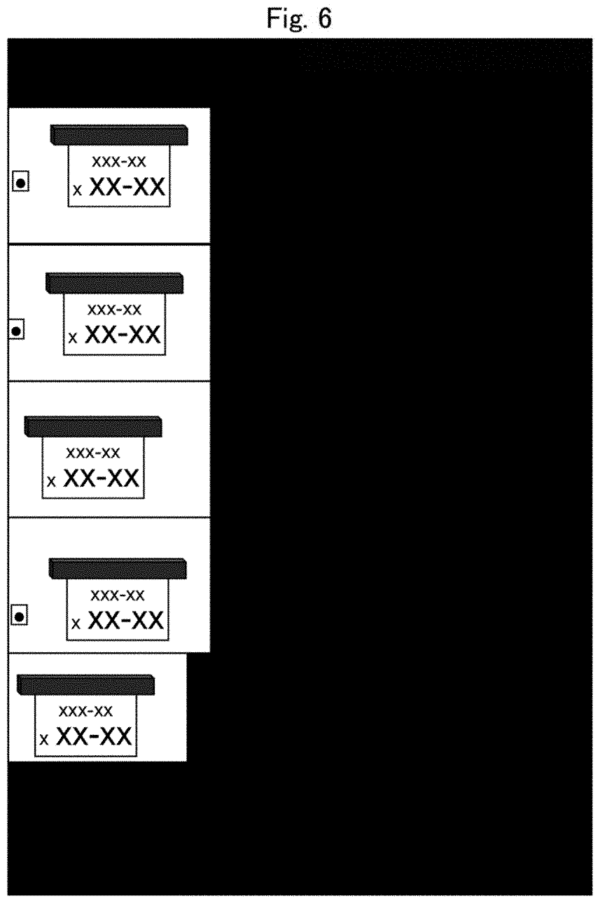

FIG. 6 is a diagram illustrating an example of the aggregated data. In FIG. 6, the display of the class and the confidence is omitted. The aggregated data of FIG. 6 is an example of the aggregated data generated by using the data of FIG. 5 and four pieces of data temporally preceding and following FIG. 5 (five pieces of data in total). The aggregated data of FIG. 6 is an example of a case where the LP is detected in any data in the primary inference for the five pieces of data. When the LP is not detected in any data, and the vehicle front and rear surface are detected, the image relevant to the data is not the LP but the image of the vehicle front and rear surface. In the example of FIG. 6, the data aggregation unit 30 makes the region of the image to be extracted larger than the region of the BB of the result of the primary inference in order to reduce the possibility that a part of the target object is missing. For example, the image of each LP is an image of a region larger than the BB of the LP. In the example illustrated in FIG. 6, the total area of the images as the result of the primary inference is smaller than the area of the image of the aggregated data. Therefore, the image of the aggregated data in FIG. 6 includes a surplus region (a black region on the right side in FIG. 6). For example, in the case of further aggregating the results of the primary inference, the data aggregation unit 30 may add at least a part of the results of the primary inference to be aggregated to the surplus region. In a case where the result of the primary inference to be added cannot completely enter the surplus region, the data aggregation unit 30 may generate new aggregated data.

The sub-target object in FIG. 5 includes the target object included in the result of the primary inference therein. That is, the sub-target object in FIG. 5 is a sub-target object having the predetermined positional relationship with the target object. Therefore, the BB of the sub-target object in FIG. 5 is not included in the aggregated data in FIG. 6. The description returns to the description with reference to FIG. 3.

In the generation of the aggregated data, the data aggregation unit 30 generates a correspondence relation (aggregation correspondence relation) between the positions of the data regions of the target object and the sub-target object included in the inference target data and the positions of the data regions of the target object and the sub-target object in the aggregated data.

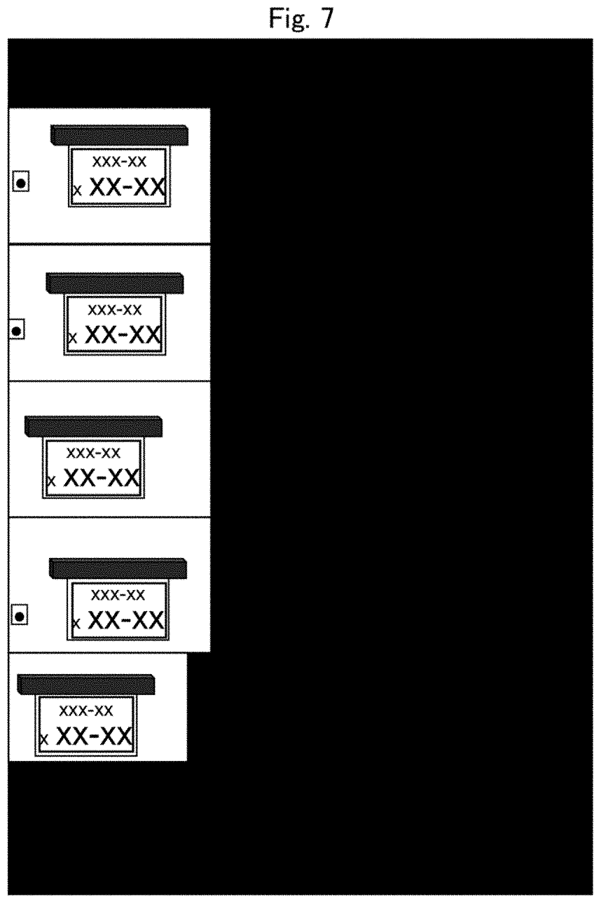

The secondary inference unit 40 executes the secondary inference by using the aggregated data (step S118). FIG. 7 is a diagram illustrating an example of the result of secondary inference. A rectangle in FIG. 7 is the BB of the target object (LP) inferred by the secondary inference unit 40. In FIG. 7, the display of the class and the confidence is omitted. The description returns to the description with reference to FIG. 3.

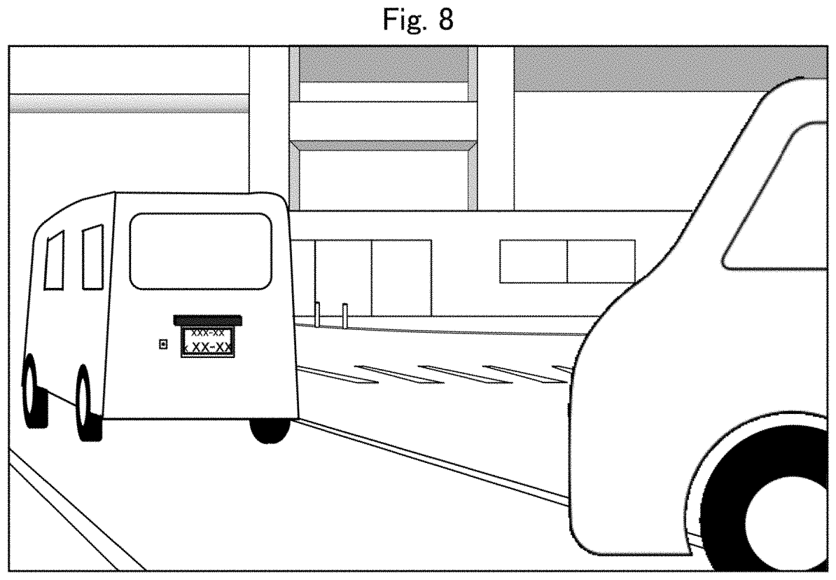

The object inference unit 10 infers the target object in the inference target data by using the result of the secondary inference and the aggregation correspondence relation (step S119). FIG. 8 is a diagram illustrating an example of the inference of the target object in the inference target data. Compared with FIG. 5, the position of the BB in FIG. 8 is an appropriate position with respect to the LP. In a case where the size of the target object included in the result of the secondary inference is larger than the size of the data aggregated in the aggregated data, the object inference unit 10 may ignore the target object. The description returns to the description with reference to FIG. 3.

The information processing device 1 repeats the above operation until a predetermined condition is satisfied. For example, the information processing device 1 may end the operation when acquiring an ending instruction from the operator. Alternatively, the information processing device 1 may repeat the above operation until there is no inference target data to be processed, until the quantity of processed inference target data reaches a predetermined value, until a predetermined time elapses, or until the number of repetitions reaches a predetermined number. Based on the above operation, the information processing device 1 infers the target object in the inference target data.

[Description of Effects]

The information processing device 1 according to the first example embodiment can achieve an effect of improving the throughput of the inference of the target object. The reason is as follows.

The information processing device 1 includes the object inference unit 10, the primary inference unit 20, the data aggregation unit 30, and the secondary inference unit 40. As the primary inference, the primary inference unit 20 applies the inference target data in which at least some data includes the first target object to the first learned model (learned model for primary inference) to infer the first target object. The data aggregation unit 30 uses the first target object inferred in the primary inference to generate the aggregated data that is data having a smaller quantity than the inference target data. The data aggregation unit 30 generates a correspondence relation (aggregation correspondence relation) between the position of the first target object in the inference target data and the position of the first target object in the aggregated data. As the secondary inference, the secondary inference unit 40 applies the aggregated data to the second learned model (learned model for secondary inference) to infer the first target object. The object inference unit 10 uses the first target object in the result of the secondary inference and the correspondence relation (aggregation correspondence relation) to infer the first target object in the inference target data.

In this manner, the information processing device 1 generates the aggregated data obtained by aggregating the regions including the target object in the inference target data by using the result of the primary inference using the inference target data. Then, the information processing device 1 infers the target object in the inference target data by using the result of the secondary inference using the aggregated data and the information (aggregation correspondence relation) related to the inference target data of the target object and the position of the aggregated data.

The aggregated data is data obtained by combining the regions of the target object in the inference target data, and is data having a smaller quantity than the inference target data. Therefore, the load of the secondary inference is lower than the load in a case where all the inference target data is used. It is sufficient if the primary inference can infer the target object with a certain degree of accuracy. That is, the information processing device 1 can use, as the primary inference, inference with a lower load than the secondary inference. As a result, the information processing device 1 can improve the throughput in inference.

The improvement in the throughput of the inference in the information processing device 1 will be described using a specific example. As inference to be compared with the information processing device 1, inference (hereinafter, referred to as “related inference”) in which a model equivalent to the learned model for secondary inference is applied to the inference target data is used. In the following description, the following is assumed as a premise.

(1) The inference target data is an image.

(2) The performance (for example, a processing speed and an accuracy) and the scale of the related inference are the same as the performance and the scale of the secondary inference in the secondary inference unit 40. The time required for inference of one image by the related inference and the secondary inference is a unit time (hereinafter, the unit time is “1”).

(3) The time required for the primary inference in the primary inference unit 20 to infer one image is 1/10 (0.1) of the related inference and the secondary inference.

(4) The data aggregation unit 30 generates one aggregated image from three images to be inferred on average (a ratio between the number of images to be inferred and the number of images as the result of the aggregation is 3:1).

(5) The total number of images is N.

(6) Processing other than the inference is ignored since the processing time is shorter than that of the inference.

In this case, the inference time of the related inference is “N×1=N”. The inference time of the primary inference in the information processing device 1 is “N×0.1=0.1N”. The inference time of the secondary inference is “N/3×1=N/3”. That is, the inference time of the information processing device 1 is “about 0.43N (=0.1N+N/3)”. In this manner, the information processing device 1 can perform inference in a shorter time than the related inference. As a result, the information processing device 1 can improve the throughput more than the related inference. The scale of the model (learned model for secondary inference) used for the final inference (secondary inference) in the information processing device 1 is equivalent to the model used for the related inference. Therefore, the inference accuracy of the information processing device 1 is equivalent to the accuracy of the related inference.

A lightweight model tends to have higher speed and lower accuracy than a weight model. For example, in the above example, the accuracy of the primary inference in the primary inference unit 20 tends to be lower than the accuracy of the secondary inference in the secondary inference unit 40. In this regard, the primary inference unit 20 may infer the second target object (sub-target object) having a predetermined positional relationship with the first target object (the inference target object in the information processing device 1). In this case, the data aggregation unit 30 may generate the aggregated data and the correspondence relation by using the first target object and the second target object (sub-target object). By using the above operation, the information processing device 1 can execute inference by using not only the inference target object (first target object) in the information processing device 1 but also the sub-target object (second target object) having the predetermined relationship with the target object. Therefore, the information processing device 1 can improve the inference accuracy. For example, the information processing device 1 can suppress the overlooking of the target object.

The data aggregation unit 30 may use, among the second target objects (sub-target objects) included in the result of the primary inference, the second target object (sub-target object) in which the first target object in the predetermined positional relationship is not included in the result of the primary inference. By using the above operation, the information processing device 1 can reduce the size of the aggregated data. As a result, the information processing device 1 can improve the throughput.

The data aggregation unit 30 may execute predetermined processing (post-processing) on at least a part of the first target object included in at least the result of the primary inference before the generation of the aggregated data. By using the above operation, the information processing device 1 can generate more appropriate aggregated data. As a result, the information processing device 1 further improves the inference accuracy. For example, the information processing device 1 suppresses the overlooking of the target object. In a case where the sub-target object is used, the information processing device 1 may execute predetermined processing (post-processing) on at least a part of the second target object (sub-target object) included in the result of the primary inference before the generation of the aggregated data.

The information processing device 1 further includes the data generation unit 60 and the model generation unit 70. The data generation unit 60 generates the first learning data set used for learning of the first learned model (learned model for primary inference) by using the first data set (original learning data set). Further, the data generation unit 60 generates the second learning data set used for learning of the second learned model (learned model for secondary inference) by using at least one of the first data set and the first learning data set. The model generation unit 70 generates the first learned model (learned model for primary inference) by using the first learning data set and generates the second learned model (learned model for secondary inference) by using the second learning data set. With the above configuration, the information processing device 1 can generate the learned model used for inference.

[Variations]

In the above description, an example of a case where there is one primary inference unit 20 and one secondary inference unit 40 has been described. However, the configuration of the information processing device 1 is not limited thereto. For example, the information processing device 1 may include a plurality of primary inference units 20. In this case, the plurality of primary inference units 20 may perform inference by using different parameters (for example, the learned model, the size of the data, or a recognition target class). All of the plurality of primary inference units 20 may perform inference by using the same inference target data. Alternatively, at least some of the primary inference units 20 may perform inference by using inference target data different from those of the other primary inference units 20.

Alternatively, for example, the information processing device 1 may include two or more secondary inference units 40. In a case where there are a plurality of secondary inference units 40, at least some of the secondary inference units 40 may perform inference by using parameters (for example, the learned model or the size of the data) different from those of the other secondary inference units 40. In a case where there are the plurality of secondary inference units 40, the data aggregation unit 30 may generate the aggregated data relevant to each secondary inference unit 40. In a case where the aggregated data relevant to each of the plurality of secondary inference units 40 is generated, the data aggregation unit 30 may generate the aggregated data by using different parameters for each of the secondary inference units 40.

Alternatively, the data aggregation unit 30 may divide the generated aggregated data and allocate the divided data to the plurality of secondary inference units 40. In the case of distributing the data to the plurality of secondary inference units 40, the data aggregation unit 30 may generate or divide the aggregated data by using, for example, the attribute of the BB in the result of the primary inference described below or a combination of these attributes. A case where the data aggregation unit 30 distributes the aggregated data to the plurality of secondary inference units 40 is either a case where the data aggregation unit 30 generates the aggregated data relevant to each of the plurality of secondary inference units 40 or a case where the aggregated data generated by the data aggregation unit 30 is divided.

(1) The size or aspect ratio of the BB,

(2) The class of the BB,

(3) The confidence of the BB,

(4) The position in the result of the primary inference of the BB, and

(5) Whether the relevant sub-target object is detected in a case where the BB is the BB of the target object.

The data aggregation unit 30 may include a part of the result (for example, the BB) of the primary inference in a plurality of pieces of generated aggregated data or a plurality of pieces of divided aggregated data. The data aggregation unit 30 may use the above-described attribute or a combination thereof in the determination as to whether to include the result of the primary inference in the plurality of pieces of aggregated data. In a case where the result of the primary inference is included in the plurality of pieces of aggregated data, there is a possibility that the plurality of secondary inference units 40 infer the same target object. In this case, it is sufficient if the object inference unit 10 determines the overlap of the target object by using the result of the secondary inference and the aggregation correspondence relation, and executes the operation in accordance with the overlap by using the determination result. For example, the object inference unit 10 may correct the result of the inference by using the overlap. For example, the object inference unit 10 may select a BB having the highest confidence among a plurality of BBs for the target object which are overlappingly inferred as the BB of the target object. Alternatively, the object inference unit 10 may average the rectangular information on the BB in a plurality of inference results as the rectangular information on the BB of the target object. The object inference unit 10 may use a weighted average based on confidence as the averaging.

In the above description, the data aggregation unit 30 corrects the size of the BB by adding a predetermined value to at least one of the height and the width of the BB of the target object and the BB of the sub-target object or multiplying at least one of the height and the width by a predetermined value. However, the first example embodiment is not limited thereto. As another example, the data aggregation unit 30 may correct the size of the BB by multiplying at least one of the height and the width of the BB of the target object and the BB of the sub-target object by a predetermined value and then adding a predetermined value. Alternatively, the data aggregation unit 30 may correct the size of the BB by applying predetermined linear or nonlinear conversion to at least one of the height and the width of the BB of the target object and the BB of the sub-target object. Parameters related to the conversion in this case may be given to the data aggregation unit 30 in advance, for example. Alternatively, the data aggregation unit 30 may switch the conversion method and the parameters related to the conversion based on the attributes of the BB and the inference target data or other information (for example, the load of the information processing device 1).

[Hardware Configuration]

In the above description, an example has been described in which the object inference unit 10, the primary inference unit 20, the data aggregation unit 30, the secondary inference unit 40, the data storage unit 50, the data generation unit 60, the model generation unit 70, the model storage unit 80, and the data acquisition unit 90 are included in one device. However, the first example embodiment is not limited thereto. For example, the information processing device 1 may be configured by connecting devices having functions corresponding to the respective configurations via a predetermined network. For example, the information processing device 1 may be achieved by using cloud computing. Alternatively, each component of the information processing device 1 may be configured by a hardware circuit. Alternatively, in the information processing device 1, a plurality of components may be configured by one piece of hardware.

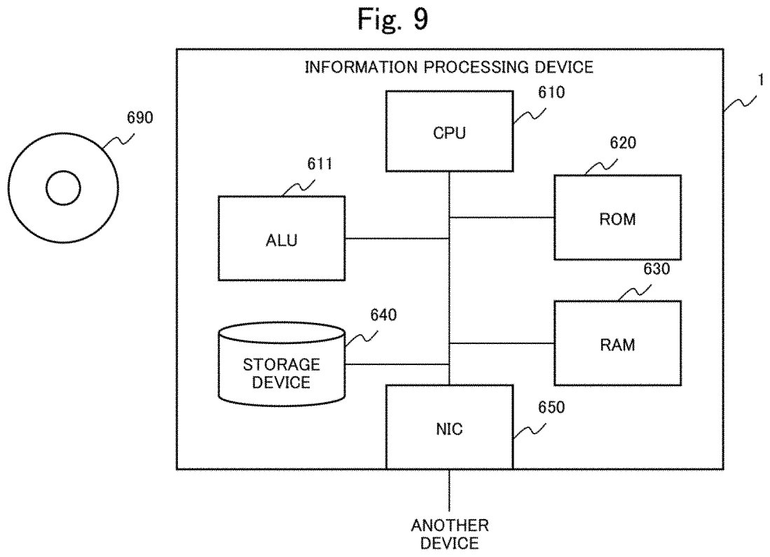

Alternatively, the information processing device 1 may be achieved as a computer device including a CPU, a read only memory (ROM), and a random access memory (RAM). In addition to the above configuration, the information processing device 1 may be achieved as a computer device including a network interface circuit (NIC). Alternatively, the information processing device 1 may be further achieved as a computer device including an arithmetic logic unit (ALU) that executes a part or all of arithmetic operations of learning and inference. FIG. 9 is a block diagram illustrating an example of a hardware configuration of the information processing device 1. The information processing device 1 of FIG. 9 includes a CPU 610, an ALU 611, a ROM 620, a RAM 630, a storage device 640, and an NIC 650, and configures a computer device.

The CPU 610 reads a program from the ROM 620 and/or the storage device 640. Then, the CPU 610 controls the RAM 630, the storage device 640, the ALU 611, and the NIC 650 based on the read program. The CPU 610 controls these configurations and achieves functions as the object inference unit 10, the primary inference unit 20, the data aggregation unit 30, the secondary inference unit 40, the data storage unit 50, the data generation unit 60, the model generation unit 70, the model storage unit 80, and the data acquisition unit 90.

When achieving each function, the CPU 610 may use the RAM 630 or the storage device 640 as a temporary storage medium of the program. The CPU 610 may read the program included in the storage medium 690 storing the program in a computer readable manner by using a storage medium reading device (not illustrated). Alternatively, the CPU 610 may receive a program from an external device (not illustrated) via the NIC 650, store the program in the RAM 630 or the storage device 640, and operate based on the stored program.

The ALU 611 is in charge of predetermined arithmetic processing and part of predetermined processing in the CPU 610. For example, the ALU 611 is controlled by the CPU 610 to execute some or all arithmetic operations of learning and inference. The configuration of the ALU 611 is optional. For example, the ALU 611 may be a graphics processing unit (GPU) or a field-programmable gate array (FPGA). Alternatively, the ALU 611 may be, for example, an application specific integrated circuit (ASIC). Information (data, a program, circuit information, and the like) necessary for the arithmetic operation in the ALU 611 is stored in advance in the ROM 620, the RAM 630, or the storage device 640.

The ROM 620 stores programs and fixed data executed by the CPU 610. The ROM 620 is, for example, a programmable ROM (P-ROM) or a flash ROM. The RAM 630 temporarily stores the programs and data executed by the CPU 610. The RAM 630 is, for example, a dynamic-RAM (D-RAM). The storage device 640 stores data and programs to be stored for a long period of time by the information processing device 1. The storage device 640 may operate as the data storage unit 50. The storage device 640 may operate as the model storage unit 80. The storage device 640 may operate as a temporary storage device of the CPU 610. The storage device 640 may operate as a secondary storage to memory (for example, the ROM 620 and the RAM 630). The storage device 640 is, for example, a hard disk device, a magneto-optical disk device, a solid state drive (SSD), or a disk array device.

The ROM 620 and the storage device 640 are non-transitory recording media. On the other hand, the RAM 630 is a transitory recording medium. The CPU 610 is operable based on the programs stored in the ROM 620, the storage device 640, or the RAM 630. That is, the CPU 610 can operate using the non-transitory recording medium or the transitory recording medium.

The NIC 650 relays exchange of data with an external device (not illustrated) via a network. The NIC 650 operates as a part of the data acquisition unit 90 and the object inference unit 10. The NIC 650 is, for example, a local area network (LAN) card. The NIC 650 is not limited to wired communication, and may be wireless communication.

The information processing device 1 of FIG. 9 configured as described above can obtain the same effects as those of the information processing device 1 of FIG. 1. This is because the CPU 610 of the information processing device 1 of FIG. 9 can achieve the same functions as those of the information processing device 1 of FIG. 1 based on the programs. Alternatively, this is because the CPU 610 and the ALU 611 of the information processing device 1 of FIG. 9 can achieve functions similar to those of the information processing device 1 of FIG. 1 based on the programs.

### [System]

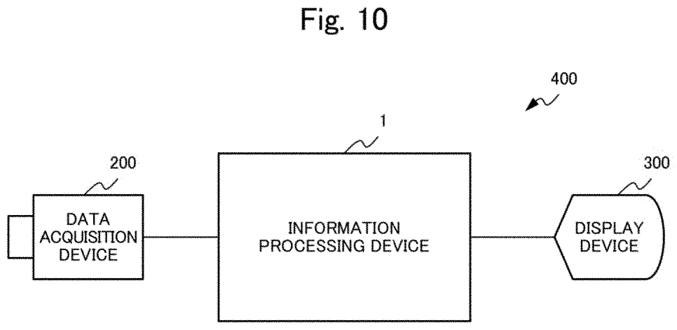

FIG. 10 is a block diagram illustrating an example of a configuration of an information processing system 400 including the information processing device 1. The information processing system 400 includes the information processing device 1, a data acquisition device 200, and a display device 300. The information processing system 400 may include a plurality of devices as the respective devices. For example, the information processing system 400 may include a plurality of data acquisition devices 200. The information processing system 400 may include a device (not illustrated). For example, the information processing system 400 may include a device (for example, an OCR device) that recognizes predetermined information related to the target object by using the inference result of the information processing device 1.

The data acquisition device 200 outputs the inference target data to the information processing device 1. The data acquisition device 200 may output the original learning data set for generating the learning data set to the information processing device 1. The data acquisition device 200 is, for example, a monitoring camera. In this case, the data acquisition device 200 outputs the captured image as the inference target data to the information processing device 1.

The information processing device 1 operates as described above. That is, the information processing device 1 acquires the inference target data from a predetermined device (for example, the data acquisition device 200). Then, the information processing device 1 infers the target object (for example, a set of “a BB, a class and confidence” of the target object) in the acquired inference target data. Then, the information processing device 1 outputs the inference result to a predetermined device (for example, the display device 300).

The display device 300 acquires the inference result (for example, a set of “a BB, a class and confidence” of the target object) from the information processing device 1 and displays the acquired inference result. The display device 300 is, for example, a liquid crystal display, an organic electroluminescence display, or electronic paper. Specifically, the display device 300 is, for example, a liquid crystal display of a monitoring system. The operator can check the target object with reference to the display on the display device 300.

As described above, the information processing system 400 includes the information processing device 1, the data acquisition device 200, and the display device 300. The information processing device 1 operates as described above. The data acquisition device 200 outputs the inference target data to the information processing device 1. The display device 300 acquires the inference result from the information processing device 1 and displays the acquired inference result. With the above configuration, the information processing system 400 displays the target object inferred in the inference target data to the operator or the like.

### Second Example Embodiment

The loads of the primary inference and the secondary inference are different for each learned model used for inference. For example, a learned model with a high inference accuracy generally has a high load. However, when the learned model with a high load is used, the throughput deteriorates. Alternatively, the load of data aggregation is different according to the post-processing and aggregation processing in the data aggregation. Alternatively, a method (for example, a method of combining regions) of generating the aggregated data used in the data aggregation and the format (for example, the size and the gap between images) of the aggregated data affect the inference accuracy.

In this manner, at least one change in the primary inference, the secondary inference, and the data aggregation (hereinafter, collectively referred to as “inference parameters”) affects the throughput and the inference accuracy in the information processing device 1. In general, the inference accuracy and the throughput are in a trade-off relationship. When the processing load is increased, the throughput is deteriorated, and when the processing load is decreased, the throughput is improved. Therefore, in order to prevent a deterioration in inference accuracy while securing a desired throughput, it is desirable to select and use an appropriate inference parameter based on the load or the throughput.

In this regard, as a second example embodiment, an example embodiment will be described in which at least one of the inference parameters (the primary inference, the secondary inference, and the data aggregation) is changed based on the load or the throughput. Hereinafter, the second example embodiment will be described with reference to the drawings. In the description of the second example embodiment, the same configurations and operations as those of the first example embodiment are denoted by the same reference numerals, and the detailed description thereof may be omitted. In the following description, in the second example embodiment, the learned model is changed as the change of the inference parameter. However, this does not limit the second example embodiment. In the second example embodiment, an inference parameter different from the learned model may be changed according to the load or the throughput. The change of the inference parameter will be further described later.

[Description of Configuration]

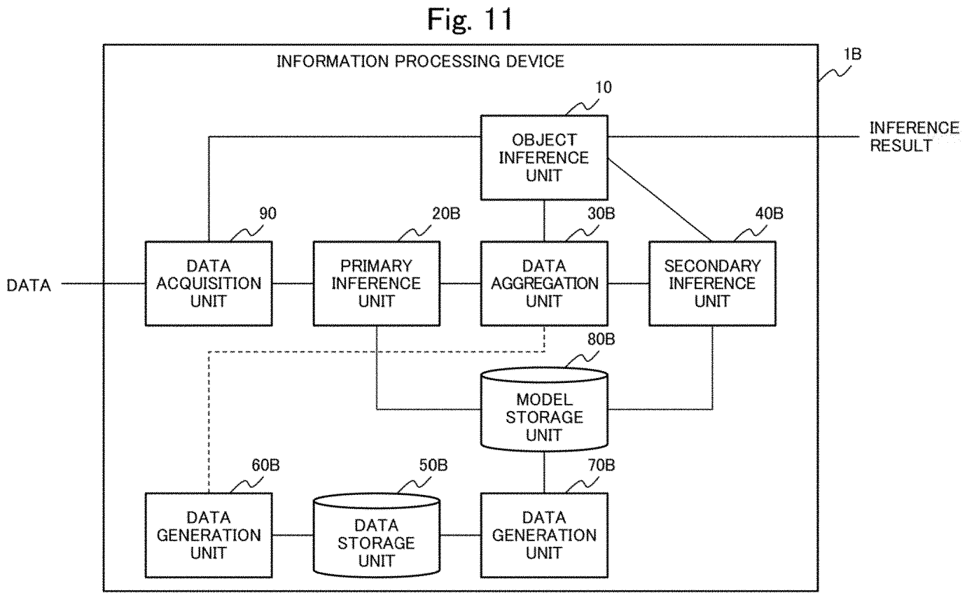

FIG. 11 is a block diagram illustrating an example of a configuration of an information processing device 1B according to the second example embodiment. The information processing device 1B includes the object inference unit 10, a primary inference unit 20B, a data aggregation unit 30B, a secondary inference unit 40B, a data storage unit 50B, a data generation unit 60B, a model generation unit 70B, a model storage unit 80B, and a data acquisition unit 90. Similarly to the first example embodiment, the information processing device 1B may be configured using a computer device as illustrated in FIG. 9.

The configuration for determining the load or throughput of the information processing device 1B is optional. For example, a monitor unit (not illustrated) may determine the load and notify each component of the load. For example, in a case where the information processing device 1B is a computer, the information processing device 1B may use a monitor of an operating system operating on the computer as the configuration for determining the load. Alternatively, a predetermined application operating on the computer may measure, as the throughput, the processing speed of one or a plurality of components. For example, the predetermined application may measure at least one of the quantity of inference target data processed by the primary inference unit 20B, the quantity of aggregated data generated by the data aggregation unit 30B, and the quantity of aggregated data processed by the secondary inference unit 40B in a unit time.

In the information processing device 1B, a configuration for controlling the operation of each component in accordance with the load or the throughput is optional. For example, the information processing device 1B may include a control unit (not illustrated) that determines the load or the throughput and controls each component. Alternatively, a predetermined configuration may determine the load or the throughput and control the operations of the components such as the primary inference unit 20B, the data aggregation unit 30B, and the secondary inference unit 40B. Alternatively, each component (for example, the primary inference unit 20B, the data aggregation unit 30B, and the secondary inference unit 40B) may determine the load or throughput and change the inference parameters related to each. Therefore, in the following description, description of the component that controls the operation in accordance with the load in the components is omitted unless otherwise necessary.

A configuration for which the load or the throughput is determined and a configuration for switching the inference parameter are optional. For example, the load or the throughput may be a load or a throughput in the entire information processing device 1B. For example, the information processing device 1B may switch the inference parameters of the primary inference unit 20B, the data aggregation unit 30B, and the secondary inference unit 40B in such a way that the throughput as the entire information processing device 1B is appropriate for the inference target data. Alternatively, the determination target of the load or the throughput may be a load or a throughput in one or some configurations of the information processing device 1B. For example, the information processing device 1B may switch the inference parameter of a certain configuration in accordance with the load or the throughput of a configuration at the preceding stage or the subsequent stage of the configuration.

For example, the primary inference unit 20B may switch the learned model for primary inference in accordance with the load of the data aggregation unit 30B. For example, in a case where the load of the data aggregation unit 30B is high, the primary inference unit 20B uses the learned model with a high load (learned model with high inference accuracy). Conversely, in a case where the load of the data aggregation unit 30B is low, the primary inference unit 20B uses the learned model with a low load. Alternatively, the secondary inference unit 40B may switch the learned model for secondary inference in accordance with the load of the data aggregation unit 30B. For example, in a case where the load of the data aggregation unit 30B is high, the secondary inference unit 40B uses the learned model with a high load (learned model with high inference accuracy). Conversely, in a case where the load of the data aggregation unit 30B is low, the secondary inference unit 40B uses the learned model with a low load.

Next, each configuration will be described. The object inference unit 10 and the data acquisition unit 90 are similar to those of the first example embodiment, and thus detailed description thereof will be omitted.

Similarly to the data generation unit 60, the data generation unit 60B generates the primary inference learning data set and the secondary inference learning data set by using the original learning data set. Then, the data generation unit 60B stores the generated primary inference learning data set and secondary inference learning data set in the data storage unit 50B. However, in the second example embodiment, at least one of the primary inference unit 20B and the secondary inference unit 40B uses a plurality of learned models. Therefore, the data generation unit 60B generates a plurality of learning data sets as at least one of the primary inference learning data set and the secondary inference learning data set.

For example, the data generation unit 60B may generate the plurality of learning data sets by applying a general data augmentation method to the original learning data set stored in the data storage unit 50B. The data augmentation method is optional. In a case where the data is an image, examples of the data augmentation method include horizontal inversion, vertical inversion, cropping, combining, enlargement or reduction, brightness adjustment, brightness adjustment, color adjustment, and combinations thereof.

Similarly to the data storage unit 50, the data storage unit 50B stores the learning data sets (the primary inference learning data set and the secondary inference learning data set) used for the generation of the learned model used by the primary inference unit 20B and the secondary inference unit 40B. However, in the second example embodiment, at least one of the primary inference unit 20B and the secondary inference unit 40B uses a plurality of learned models. Therefore, the data storage unit 50B stores the plurality of learning data sets as at least one of the primary inference learning data set and the secondary inference learning data set.

Similarly to the model generation unit 70, the model generation unit 70B generates the learned model (the learned model for primary inference and the learned model for secondary inference) by using the learning data set. However, in the second example embodiment, at least one of the primary inference unit 20B and the secondary inference unit 40B uses a plurality of learned models. Therefore, the model generation unit 70B generates the plurality of learned models as at least one learned model of the learned model for primary inference and the learned model for secondary inference. Then, the model generation unit 70B stores the generated learned model in the model storage unit 80B. Specifically, the model generation unit 70B generates the plurality of learned models as at least one learned model of the learned model for primary inference and the learned model for secondary inference by using the plurality of learning data sets stored in the data storage unit 50B. However, the model generation unit 70B may generate the plurality of learned models by using one learning data set.

The plurality of learned models generated by the model generation unit 70B are optional. For example, the model generation unit 70B may generate, as the learned model, a model in which any one of the following is different.

(1) The learning data set used for learning,

(2) The network structure of the model,

(3) The hyper-parameters of the model,

(4) The weight accuracy included in the model,

(5) The batch size in the model,

(6) The positional relationship of the sub-target object with respect to the target object, and

(7) The number of the sub-target objects with respect to the target object.

The model generation unit 70B may generate an index to be used for selection of the learned model with respect to the plurality of generated learned models. For example, the model generation unit 70B may generate, as the index of selection of the learned model, a value such as a processing load, throughput performance, scale, or size of the generated learned model or a comparison result of at least a part of these.

The model storage unit 80B stores the learned model similarly to the model storage unit 80. However, in the second example embodiment, at least one of the primary inference unit 20B and the secondary inference unit 40B uses a plurality of learned models. Therefore, the model storage unit 80B stores the plurality of learned models as at least one learned model of the learned model for primary inference and the learned model for secondary inference.

The data aggregation unit 30B generates the aggregated data similarly to the data aggregation unit 30. However, the data aggregation unit 30B may change the data aggregation (at least one of the post-processing and the data aggregation processing) in accordance with a predetermined load or throughput in the information processing device 1B. The change of the data aggregation in the data aggregation unit 30B will be further described later.

The primary inference unit 20B executes the primary inference similarly to the primary inference unit 20. The secondary inference unit 40B executes the secondary inference similarly to the secondary inference unit 40. At least one of the primary inference unit 20B and the secondary inference unit 40B switches the learned model used for inference in accordance with the predetermined load or throughput in the information processing device 1B. At least one of the primary inference unit 20B and the secondary inference unit 40B may switch between three or more learned models instead of two. In a case where both the primary inference unit 20B and the secondary inference unit 40B switch the learned model, the primary inference unit 20B and the secondary inference unit 40B may use the same threshold or may use different thresholds as the threshold used for the determination of the load or the throughput.

The load and the throughput used for the determination in the second example embodiment are optional. It is sufficient if the operator determines the load or throughput used for the determination based on the target object, the learned model, and the like. For example, the information processing device 1B may use at least one of the following items as the load or the throughput. The information processing device 1B may use a combination of two or more items instead of one item. In a case where the following values are used, the information processing device 1B may use statistical processing such as averaging.

(1) Hardware resources related to the arithmetic operation configuring the information processing device 1B,

(1-1) The usage rate or an operation rate of at least one of the CPU and the ALU (a GPU, a FPGA, or an ASIC),

(1-2) The length of a data queue for processing in at least one of the configurations in the information processing device 1B, or a processing waiting time,

(1-3) A measurement value (for example, a temperature or power consumption) of a sensor (not illustrated) included in the information processing device 1B, (2) The size of the inference target data,
(3) The result (for example, the number or area of BBs to be subjected to post-processing) of the primary inference in the primary inference unit 20B,
(4) The result of the post-processing in the data aggregation unit 30B (for example, the number or area of BB after the post-processing),
(5) The result of the aggregation in the data aggregation unit 30B (for example, the size of the aggregated data),
(6) A ratio between the size of the inference target data and the size of the aggregated data,
(7) The result (for example, the number or area of BBs included in the secondary inference) of the secondary inference in the secondary inference unit 40B, and

(8) The processing time (the processing time may be an actually measured time or a time calculated by using a relationship between the size of the inference target data set in advance and the processing time) of at least one of the primary inference and the secondary inference.

The information processing device 1B may switch the inference parameter based on another information instead of the load and the throughput or together with the load or the throughput. For example, the imaging range of a monitoring camera of a system that detects an intruder may include a range in which a required inference accuracy is different. For example, it is desirable that the range near an entrance has a high inference accuracy. On the other hand, in the range far from the entrance, in order to reduce unnecessary power consumption, it is desirable to reduce the load necessary for inference even when the inference accuracy is low. In this regard, for example, the information processing device 1B usually uses the inference parameter (for example, the learned model with a low load) with a low load. Then, in a case where a sensor (for example, a human sensor) detects the intrusion (for example, an approach to the vicinity of the entrance) of a person into a predetermined range, the information processing device 1B may switch to the inference parameter (for example, the learned model with a high inference accuracy) in which the inference accuracy becomes high. In this manner, the information processing device 1B may switch the inference parameter in accordance with predetermined information such as an event detected by the sensor.

The inference parameters in the primary inference unit 20B and the secondary inference unit 40B are changed as follows including the change of the learned model in the above description. However, the change of the inference parameter is not limited to the following.

(1) The Change of the Learned Model Used for Inference:

When the learned model with a low load is used, the throughput of the primary inference unit 20B and the secondary inference unit 40B is improved. However, the inference accuracy deteriorates. In a case where the learned model having a high load but a high accuracy is used, the throughput of the primary inference unit 20B and the secondary inference unit 40B deteriorates. However, the inference accuracy is improved.

(2) The Change of a Predetermined Quantity for Collectively Executing the Primary Inference:

In a case where the predetermined quantity for collectively executing the primary inference is reduced, the information processing device 1 can shorten a time (latency) until a final inference result for the inference target data is obtained.

Next, the change of the inference parameter (in particular, the data aggregation) related to the data aggregation unit 30B will be described. The data aggregation unit 30B may change the following inference parameter based on the predetermined load or throughput in the information processing device 1B.

(1) The Change of the Parameter (for Example, a Threshold or a Correction Amount of BB in BB Filtering or BB Adjustment) in the Data Aggregation:

In a case where the threshold of the filtering is changed in such a way as to reduce the number of filtering targets (to reduce the quantity of data after filtering), the throughput of the data aggregation unit 30B is improved. However, the inference accuracy in the secondary inference unit 40B deteriorates. In a case where the threshold of the filtering is changed in such a way as to increase the number of filtering targets (to increase the quantity of data after filtering), the throughput of the data aggregation unit 30B deteriorates. However, the inference accuracy in the secondary inference unit 40B is improved.

(2) The Change of a Gap Provided Between Data to be Duplicated in the Aggregated Data:

In a case where the gap is narrowed, the throughput of the data aggregation unit 30B is improved. However, the inference accuracy in the secondary inference unit 40B deteriorates. In a case where the gap is widened, the throughput of the data aggregation unit 30B deteriorates. However, the inference accuracy in the secondary inference unit 40B is improved.

(3) A Method of Combining Regions:

(3-1) The Change as to Whether Overlapping Regions and Adjacent Regions are Combined:

In the case of not combining the regions, the throughput of the data aggregation unit 30B is improved. However, the inference accuracy in the secondary inference unit 40B deteriorates. In the case of combining the regions, the throughput of the data aggregation unit 30B deteriorates. However, the inference accuracy in the secondary inference unit 40B is improved.

(3-2) The Change of a Distance for Determining Adjacency:

In a case where the distance for determining the adjacency is shortened, the throughput of the data aggregation unit 30B is improved. However, the inference accuracy in the secondary inference unit 40B deteriorates. In a case where the distance for determining the adjacency is increased, the throughput of the data aggregation unit 30B deteriorates. However, the inference accuracy in the secondary inference unit 40B is improved.

(4) The Change of the Size of the Aggregated Data:

In a case where the size of the aggregated data is reduced, the throughput of the data aggregation unit 30B is improved. However, the inference accuracy in the secondary inference unit 40B deteriorates. In a case where the size of the aggregated data is increased, the throughput of the data aggregation unit 30B deteriorates. However, the inference accuracy in the secondary inference unit 40B is improved.

The information processing device 1B may change, as the inference parameters, the items related to a plurality of components as follows.

(1) The Change of the Use of the Sub-Target Object:

The information processing device 1B may switch whether to use the sub-target object according to the load. In a case where the sub-target object is not used, the throughput of the information processing device 1B is improved. However, the final inference accuracy deteriorates. In a case where the sub-target object is used, the throughput of the information processing device 1B deteriorates. However, the final inference accuracy is improved.

(2) The Presence or Absence of the Primary Inference:

The information processing device 1B may switch whether to use the primary inference (primary inference unit 20B) according to the load. In a case where the primary inference is not used in a situation where the quantity of aggregated data is large, the throughput of the information processing device 1B is improved. In a case where the primary inference is used in a situation where the quantity of aggregated data is large, the throughput of the information processing device 1B deteriorates. As described above, the switching of the primary inference included in the inference parameter includes the presence or absence of execution of the primary inference. The operation of other components in a case where the primary inference is not used is optional. For example, in a case where the primary inference is not used, the data aggregation unit 30B may generate the aggregated data by using the inference target data. Alternatively, in a case where the primary inference is not used, the secondary inference unit 40B may infer the target object in the inference target data as the secondary inference.

[Description of Operation]

Next, an operation of the information processing device 1B according to the second example embodiment will be described with reference to the drawings. In the following description, an average value (hereinafter referred to as “aggregated data generation speed”) of the quantity of the aggregated data generated per unit time by the data aggregation unit 30B is used as an example of the load. The learned model (learned model for primary inference) used by the primary inference unit 20B is used as the inference parameter to be changed. The information processing device 1B operates in such a way as to obtain higher inference accuracy in a situation where the load is low. Specifically, in a case where the aggregated data generation speed is equal to or less than a threshold (in a case where the load is low), the primary inference unit 20B uses the learned model with high accuracy (that is, the learned model with a high load) for the primary inference. On the other hand, in a case where the aggregated data generation speed exceeds the threshold (in a case where the load is high), the primary inference unit 20B uses the learned model with a low load (that is, the learned model with low accuracy) for the primary inference.

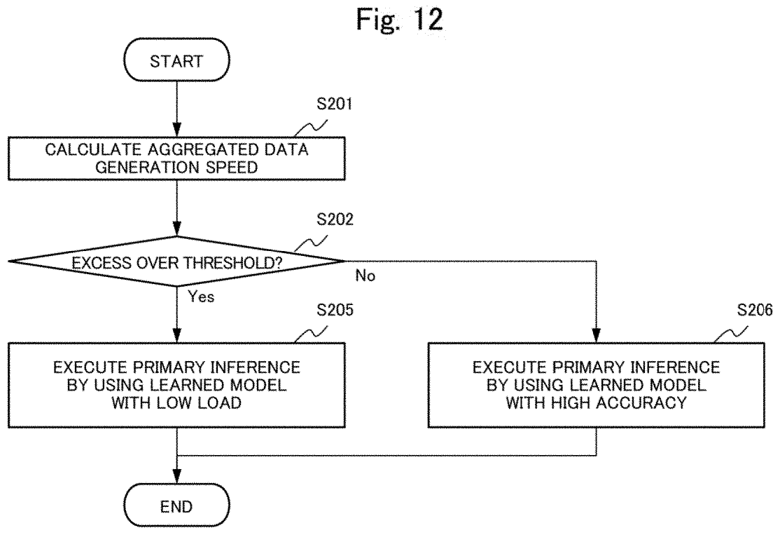

FIG. 12 is a flowchart illustrating an example of a model switching operation in the information processing device 1B according to the second example embodiment. FIG. 12 is an example of an operation in which the primary inference unit 20B switches the learned model for primary inference used for the primary inference in accordance with the aggregated data generation speed. The information processing device 1B calculates the aggregated data generation speed (step S201). The information processing device 1B determines whether the aggregated data generation speed exceeds the predetermined threshold (step S202). When the aggregated data generation speed exceeds the threshold (Yes in step S202), the primary inference unit 20B executes the primary inference by using the learned model with a low load as the primary inference (step S205). When the aggregated data generation speed is equal to or less than the threshold (No in step S202), the primary inference unit 20B executes the primary inference by using the learned model with high accuracy as the primary inference (step S206). The information processing device 1B repeats the above operation at predetermined intervals. Using such an operation, the information processing device 1B switches the learned model for primary inference used by the primary inference unit 20B in accordance with the throughput (or load) of the data aggregation unit 30B.

[Description of Effects]

The information processing device 1B according to the second example embodiment can further improve the throughput in addition to the effects of the first example embodiment. Alternatively, the information processing device 1B according to the second example embodiment can improve the inference accuracy in addition to the effects of the first example embodiment. The reason is as follows.

The information processing device 1B switches at least one of the inference parameters (the primary inference, the secondary inference, and the data aggregation) based on the predetermined load or throughput in the information processing device 1B. For example, the information processing device 1B switches the operation or the data to be handled of at least one of the primary inference unit 20B, the secondary inference unit 40B, and the data aggregation unit 30B based on the predetermined load or throughput in the information processing device 1B.

For example, the information processing device 1B switches at least one of the learned model for primary inference used by the primary inference unit 20B and the learned model for secondary inference used by the secondary inference unit 40B based on the load or throughput of the data aggregation unit 30B. Alternatively, the information processing device 1B switches the data aggregation processing in the data aggregation unit 30B based on the load or throughput of the primary inference unit 20B or the secondary inference unit 40B. In this manner, the information processing device 1B according to the second example embodiment changes the inference parameter according to the predetermined load or throughput in the information processing device 1B.

By using such an operation, the information processing device 1B suppresses a deterioration in throughput and avoids the generation of data that cannot be processed when the load increases. On the other hand, when the load decreases, the information processing device 1B switches the inference parameter in such a way that the load increases. By using such an operation, the information processing device 1B achieves the inference with an appropriate accuracy while securing the throughput.

### Third Example Embodiment

The information processing devices 1 and 1B may acquire the learned model for primary inference and the learned model for secondary inference from another device (not illustrated). Alternatively, the information processing devices 1 and 1B may use the inference target data stored in a predetermined storage device.

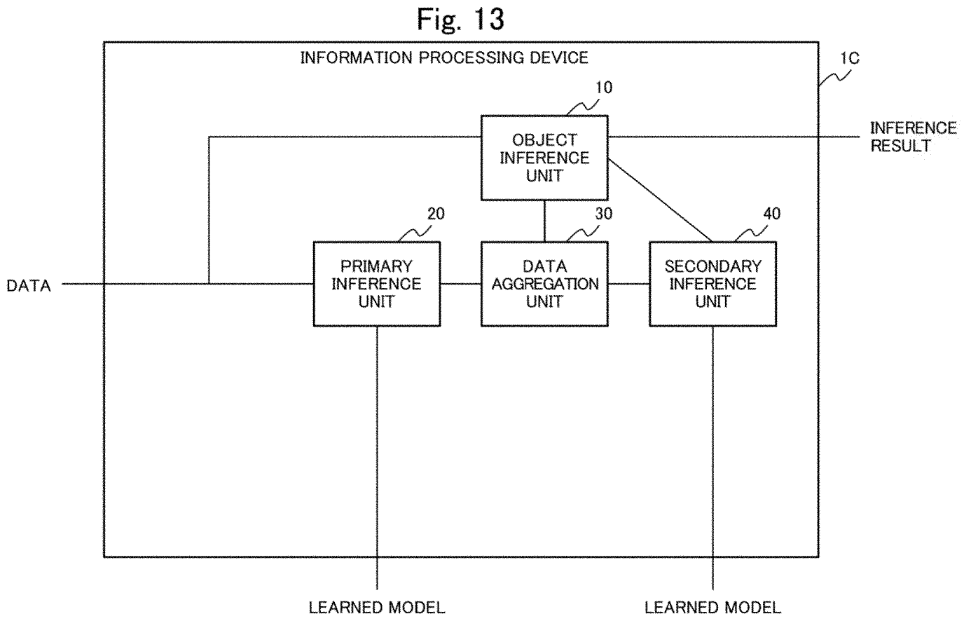

FIG. 13 is a block diagram illustrating an example of a configuration of an information processing device 1C according to the third example embodiment. The information processing device 1C includes the object inference unit 10, the primary inference unit 20, the data aggregation unit 30, and the secondary inference unit 40. As the primary inference, the primary inference unit 20 applies inference target data in which at least part of data includes the first target object to the first learned model to infer the first target object. The data aggregation unit 30 generates the aggregated data that is data having a smaller quantity than the inference target data by using the first target object inferred in the primary inference. The data aggregation unit 30 generates a correspondence relation between the position of the first target object in the inference target data and the position of the first target object in the aggregated data. As the secondary inference, the secondary inference unit 40 applies the aggregated data to the second learned model to infer the first target object. The object inference unit 10 infers the first target object in the inference target data by using the first target object in the result of the secondary inference and the correspondence relation.

The information processing device 1C configured as described above can obtain the same effects as those of the information processing device 1. That is, the information processing device 1C can achieve an effect of improving the throughput of inference of an object. The information processing device 1C has the minimum configuration of the information processing device 1.

A high throughput is required for the processing of the object detection task. For example, in order to prevent overlooking, a monitoring camera needs to acquire an image at a high frame rate to some extent. In particular, in the case of targeting an object moving at a high speed such as a car, the monitoring camera is desired to operate at a frame rate of 10 frame per second (fps) or more, for example. Therefore, the object detection task needs to detect an object in a high-frame-rate image acquired by the monitoring camera.

In a system that detects an object in the image acquired by the monitoring camera, a configuration is assumed in which the monitoring camera or a device (that is, an edge) around the monitoring camera executes inference processing in the object detection task. However, in the edge, an installation place, cooling, power, and the like are restricted, and only limited calculation resources can be used in many cases. The processing of the object detection task is required to have a high throughput to some extent even in such an edge environment.

However, the processing of inference using machine learning, particularly the processing of the object detection task, is processing that requires a high calculation load and a lot of time for processing. As a result, the object detection task generally has a low throughput performance. In this regard, it is desired to improve the throughput of the inference processing in the object detection task.

Shaoqing Ren, Kaiming He, Ross Girshick, Jian Sun, “Faster R-CNN: Towards Real-Time Object Detection with Region Proposal Networks”, [online], Jan. 6, 2016, Cornel University, [searched on Mar. 1, 2021], Internet <URL: https://arxiv.org/abs/1506.01497>, Wei Liu, Dragomir Anguelov, Dumitru Erhan, Christian Szegedy, Scott Reed, Cheng-Yang Fu, Alexander C. Berg, “SSD: Single Shot MultiBox Detector”, [online], Dec. 29, 2016, Cornel University, [searched on Mar. 1, 2021], Internet, <URL: https://arxiv.org/abs/1512.02325>, Tsung-Yi Lin, Priya Goyal, Ross Girshick, Kaiming He, Piotr Dollar, “Focal Loss for Dense Object Detection”, [online], International Conference on Computer Vision (ICCV), 2017, pp. 2980-2988, [searched on Mar. 1, 2021], Internet, <URL: https://openaccess.thecvf.com/content_ICCV_2017/papers/Lin_Focal_Loss_for_ICCV_2 017_paper.pdf> which are described below disclose techniques related to an object detection task using deep-learning. However, Shaoqing Ren, Kaiming He, Ross Girshick, Jian Sun, “Faster R-CNN: Towards Real-Time Object Detection with Region Proposal Networks”, [online], Jan. 6, 2016, Cornel University, [searched on Mar. 1, 2021], Internet <URL: https://arxiv.org/abs/1506.01497>, Wei Liu, Dragomir Anguelov, Dumitru Erhan, Christian Szegedy, Scott Reed, Cheng-Yang Fu, Alexander C. Berg, “SSD: Single Shot MultiBox Detector”, [online], Dec. 29, 2016, Cornel University, [searched on Mar. 1, 2021], Internet, <URL: https://arxiv.org/abs/1512.02325>, Tsung-Yi Lin, Priya Goyal, Ross Girshick, Kaiming He, Piotr Dollar, “Focal Loss for Dense Object Detection”, [online], International Conference on Computer Vision (ICCV), 2017, pp. 2980-2988, [searched on Mar. 1, 2021], Internet, <URL: https://openaccess.thecvf.com/content_ICCV_2017/papers/Lin_Focal_Loss_for_ICCV_2 017_paper.pdf> do not disclose a technology related to improvement in throughput of inference processing. That is, Shaoqing Ren, Kaiming He, Ross Girshick, Jian Sun, “Faster R-CNN: Towards Real-Time Object Detection with Region Proposal Networks”, [online], Jan. 6, 2016, Cornel University, [searched on Mar. 1, 2021], Internet <URL: https://arxiv.org/abs/1506.01497>, Wei Liu, Dragomir Anguelov, Dumitru Erhan, Christian Szegedy, Scott Reed, Cheng-Yang Fu, Alexander C. Berg, “SSD: Single Shot MultiBox Detector”, [online], Dec. 29, 2016, Cornel University, [searched on Mar. 1, 2021], Internet, <URL: https://arxiv.org/abs/1512.02325>, Tsung-Yi Lin, Priya Goyal, Ross Girshick, Kaiming He, Piotr Dollar, “Focal Loss for Dense Object Detection”, [online], International Conference on Computer Vision (ICCV), 2017, pp. 2980-2988, [searched on Mar. 1, 2021], Internet, <URL: https://openaccess.thecvf.com/content_ICCV_2017/papers/Lin_Focal_Loss_for_ICCV_2 017paper.pdf> have a problem that the throughput of the object detection task cannot be improved.

According to the present invention, it is possible to achieve an effect of improving the throughput of inference of a target object.

While the present invention has been described with reference to exemplary embodiments as above, the present invention is not limited to these exemplary embodiments. It will be understood by those of ordinary skill in the art that various changes in form and details may be made therein without departing from the spirit and scope of the present invention as defined by the claims.

1. An information processing device comprising:
a memory; and
at least one processor coupled to the memory,
the processor performing operations, the operations comprising:
applying inference target data in which at least part of data includes a first target object to a first learned model to infer the first target object as primary inference;
generating aggregated data that is data having a smaller quantity than the inference target data by using the first target object inferred in the primary inference;
generating a correspondence relation between a position of the first target object in the inference target data and a position of the first target object in the aggregated data;
applying the aggregated data to a second learned model to infer the first target object as secondary inference; and
inferring the first target object in the inference target data by using the first target object in a result of the secondary inference and the correspondence relation.

2. The information processing device according to claim 1, wherein the operations further comprise:
inferring a second target object having a predetermined positional relationship with the first target object, and
generating the aggregated data and the correspondence relation by using the first target object and the second target object.

3. The information processing device according to claim 2, wherein the operations further comprise:
using, among the second target objects included in a result of the primary inference, the second target object in which the first target object in the positional relationship is not included in the result of the primary inference.

4. The information processing device according to claim 1, wherein the operations further comprise:
executing predetermined processing on at least a part of the first target object included in the result of the primary inference before generating the aggregated data.

5. The information processing device according to claim 1, wherein the operations further comprise:
generating a first learning data set used for learning of the first learned model by using a first data set;
generating a second learning data set used for learning of the second learned model by using at least one of the first data set and the first learning data set;
generating the first learned model by using the first learning data set;
generating the second learned model by using the second learning data set.

6. The information processing device according to claim 1, wherein the operations further comprise:
switching at least one of the primary inference, the secondary inference, and data aggregation based on a predetermined load or throughput in the information processing device.

7. An information processing method comprising:
applying inference target data in which at least part of data includes a first target object to a first learned model to infer the first target object as primary inference;
generating aggregated data that is data having a smaller quantity than the inference target data by using the first target object inferred in the primary inference;
generating a correspondence relation between a position of the first target object in the inference target data and a position of the first target object in the aggregated data;
applying the aggregated data to a second learned model to infer the first target object as secondary inference; and
inferring the first target object in the inference target data by using the first target object in a result of the secondary inference and the correspondence relation.

8. A non-transitory computer-readable recording medium embodying a program, the program causing a computer to perform a method, the method comprising:
applying inference target data in which at least part of data includes a first target object to a first learned model to infer the first target object as primary inference;
generating aggregated data that is data having a smaller quantity than the inference target data by using the first target object inferred in the primary inference;
generating a correspondence relation between a position of the first target object in the inference target data and a position of the first target object in the aggregated data;
applying the aggregated data to a second learned model to infer the first target object as secondary inference; and
inferring the first target object in the inference target data by using the first target object in a result of the secondary inference and the correspondence relation.
